(19) United States
(12) Patent Application Publication
(10) Pub. No.: US 2025/0232024 A1
(43) Pub. Date: Jul. 17, 2025

(54) SYSTEM FOR GENERATING AND AUTHENTICATING SOCIAL IDENTITY OF OBJECTS DATA USING LARGE LANGUAGE MODEL(S)

(71) Applicant: Invisible Holdings LLC, Sheridan, WY (US)

(72) Inventors: Raymond Francis St. Martin, Felton, CA (US); Andrew Lee Van Valer, Reno, NV (US)

(21) Appl. No.: 19/026,063

(22) Filed: Jan. 16, 2025

Related U.S. Application Data
(60) Provisional application No. 63/621,952, filed on Jan. 17, 2024.

(51) Int. Cl. G06F 21/45

(52) U.S. Cl. CPC G06F 21/45

(57) ABSTRACT

Interactive search trust assessment systems and techniques are described. In some examples, an interactive search trust assessment system receives a prompt associated with a search for information about an object. The prompt is based on a user input and data from a data structure. The interactive search trust assessment system processes the prompt using a trained machine learning model to generate a response. The response is responsive to the prompt. The response includes the information about the object retrieved from the data structure as a result of the search. The interactive search trust assessment system generates a response trust score associated with the response. The response trust score is based on one or more trust scores associated with the information about the object retrieved from the data structure. The interactive search trust assessment system outputs the response based on the response trust score exceeding a threshold.

### CROSS-REFERENCE TO RELATED APPLICATIONS

The present application claims the priority benefit of U.S. Provisional Patent Application No. 63/621,952 filed on Jan. 17, 2024, entitled “System for Generating and Authenticating Social Identity of Objects Utilizing Large Language Models”, the disclosures of which are all incorporated herein by reference in their entireties.

### FIELD OF THE DISCLOSURE

The present disclosure is generally related to generating data points associated with an object and/or performing assessment of data points associated with an object, and more particularly relating to analyzing and/or authenticating data points associated with an object based on an input and authenticity data associated with the input.

### BACKGROUND

When generating data associated with an object based on user-provided information, it is difficult to maintain consistent data quality due to the absence of expert intervention to determine the authenticity or authority level of the information. Additionally, it is difficult to include extensive information about a wide array of objects, and iteratively refine or augment previously generated data due to the limitation in scope of the user-provided information. Therefore, it is desirable to devise a way to enhance scalable data generation and authentication of the generated data.

### SUMMARY

Examples of the present technology include a method and a system for trust assessment in interactive search. In some examples, an interactive search trust assessment system receives a prompt associated with a search for information about an object. The prompt is based on a user input and data from a data structure. The interactive search trust assessment system processes the prompt using a trained machine learning model to generate a response. The response is responsive to the prompt. The response includes the information about the object retrieved from the data structure as a result of the search. The interactive search trust assessment system generates a response trust score associated with the response. The response trust score is based on one or more trust scores associated with the information about the object retrieved from the data structure. The interactive search trust assessment system outputs the response based on the response trust score exceeding a threshold.

In some examples, a method for trust assessment in interactive search includes receiving a prompt associated with a search for information about an object. The prompt is based on a user input and data from a data structure. The method includes processing the prompt using a trained machine learning model to generate a response. The response is responsive to the prompt. The response includes the information about the object retrieved from the data structure as a result of the search. The method includes generating a response trust score associated with the response. The response trust score is based on one or more trust scores associated with the information about the object retrieved from the data structure. The method includes outputting the response based on the response trust score exceeding a threshold.

In some examples, a system for trust assessment in interactive search includes a memory and a processor that executes instructions in memory. Execution of the instructions by the processor causes the processor to perform operations. The operations include receiving a prompt associated with a search for information about an object. The prompt is based on a user input and data from a data structure. The operations include processing the prompt using a trained machine learning model to generate a response. The response is responsive to the prompt. The response includes the information about the object retrieved from the data structure as a result of the search. The operations include generating a response trust score associated with the response. The response trust score is based on one or more trust scores associated with the information about the object retrieved from the data structure. The operations include outputting the response based on the response trust score exceeding a threshold.

In some examples, a non-transitory computer-readable storage medium has a program executable by a processor to perform a method for trust assessment in interactive search. The method includes receiving a prompt associated with a search for information about an object. The prompt is based on a user input and data from a data structure. The method includes processing the prompt using a trained machine learning model to generate a response. The response is responsive to the prompt. The response includes the information about the object retrieved from the data structure as a result of the search. The method includes generating a response trust score associated with the response. The response trust score is based on one or more trust scores associated with the information about the object retrieved from the data structure. The method includes outputting the response based on the response trust score exceeding a threshold.

### BRIEF DESCRIPTION OF THE DRAWINGS

The accompanying drawings illustrate various examples of systems, methods, and various other aspects of the examples. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 is a block diagram illustrating an architecture of an object generation and authentication system, according to some examples.

FIG. 2 is a flow diagram illustrating a process generating and authenticating SIO data, according to some examples.

FIG. 3 is a flow diagram illustrating a process performed by authentication module, according to some examples.

FIG. 4 is a flow diagram illustrating a process performed by SIO enabled prompt module, according to some examples.

FIG. 5 is a flow diagram illustrating a process performed by LLM module, according to some examples.

FIG. 6 is a flow diagram illustrating a process performed by iterative refinement module, according to some examples.

FIG. 7 is a flow diagram illustrating a process performed by conversion module, according to some examples.

FIG. 8 is a flow diagram illustrating a process performed by assessment module, according to some examples.

FIG. 9 is a table illustrating exemplary details about different exemplary categories of SIO data in the SIO database, according to some examples.

FIG. 10 is a block diagram illustrating a retrieval augmented generation (RAG) system that may be used to implement some aspects of the technology, according to some examples.

FIG. 11 is a block diagram illustrating an example of a machine learning system, according to some examples.

FIG. 12 is a flow diagram illustrating an example of a process for trust assessment in interactive search, according to some examples.

### DETAILED DESCRIPTION

Many of the examples described herein are described in terms of sequences of actions to be performed by, for example, elements of a computing device. It should be recognized by those skilled in the art that specific circuits can perform the various sequence of actions described herein (e.g., application-specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein.

Physical, digital representations, and digitally native objects have origin stories and narratives, having either been made by someone, something, some event, somewhere, at some time.

In some examples, virtual objects, referred to herein also as data elements, can provide details about various properties of an object, subjects and/or events and/or people related to the object, and so forth. An object boundary may change over time, but it has a visible, machine readable, human comprehensible or tangible surface and specific properties. The aggregation of data from a plurality of sources may facilitate the creation of a narrative, story or timeline of events which may document such changes.

For example, a ball is spherical. However, the sphere may have unique properties (i.e., a tennis ball is fuzzy, a marble is smooth. a golf ball has surface dimples, or a combination thereof). Therefore, the form of a sphere may have infinite properties attached to it. Therefore, an object has an identity that may change over time, with changes capable of being tracked and annotated in real-time. The initial object identity may change based on outside physical forces or input but can also be augmented and amplified by information associated with the object itself. Such properties may be provided from a plurality of sources which may then be associated with similar accounts to create a more complete collection of properties describing the object. Such properties, the outside physical forces or inputs, and/or other information about the ball may be examples of data elements.

Data elements and objects can be enhanced by using a Social Identity of Objects (SIO) system, which may be implemented using the systems and methods discussed herein.

An SIO system, and its technical framework of data and information, seamlessly associate all relevant information about a specific object and provide an increasingly valuable currency as a repository, sharing, and exchange platform. Examples of the SIO system may comprise the aggregation of a plurality of data sources and types of data to create a cohesive narrative, story, timeline, view of relationships, or account of an object or collection of objects. An aggregation of data related to a person, place, and/or event from a plurality of sources may provide a more complete description of said person, place, and/or event, including context which might otherwise be overlooked or missing.

The utility of the SIO spans a variety of applications, including but not limited to digital archiving, content generation, and enhanced user interaction with physical or virtual objects. In digital ecosystems, SIOs and SIO codes—their globally unique identifiers—serve as a comprehensive profile for objects, cataloging both tangible attributes and intangible narratives or experiences associated with them.

Technologies discussed herein allow an individual to interface with various devices that enable an enhanced understanding of the status and context of an object. For example, sensors can monitor systems and operating components of a house, and fitness trackers can help individuals understand more about their body's physical characteristics and performance. Objects can now combine technologies from multiple areas and integrate them into new infrastructures, providing a more robust and contextual experience for the user. As this process continues to grow and develop, we can reasonably expect every physical object will be identified with a unique internet address, allowing novel ways to experience and interact with physical objects and associated events connected to those objects. New information layers surrounding physical objects shape how users interact and connect the physical and virtual worlds.

Accelerating technological developments can allow people to interact with objects on a new level in the virtual world via augmented reality (AR) and artificial intelligence (AI) capabilities. Information layers and narratives from various sources will be associated with specific objects, events, and products-enhancing value, engagement, and relationships with these objects, essentially creating a mixed reality environment with the convergence and synchronization of the real and virtual worlds. SIO is implementing a personal approach to capturing, analyzing, and displaying data, realizing that subjectivity and context can play a defining role in understanding objects, events, social changes, and culture.

The systems and methods discussed herein are associated with processes of discovering objects through a system of relationships, attributes, and context of specific objects. Searches can be made in various ways and can be associated with a single type or choice of the different types of searches outlined hereafter in this document. The searches can be made based on any attributes or relationships of the SIO's within a single database or group of public or private databases.

Search examples might include color, size, date, retailer, container size, and relationships to other SIOs connecting unlimited associations or attributes attached with each type of registered or non-registered user by a menu-driven by choices. Furthermore, incorporating parameters such as the level of trust, truth, or reputation of the source or creator of an SIO can significantly enhance the search functionality. This addition can allow users to filter and prioritize search results based on the credibility and authenticity of the information associated with each object. By integrating these metrics, the system can provide a more comprehensive and reliable search experience, ensuring that users not only find what they are looking for but also can trust the validity and reputation of the information presented.

In some examples, individual users can deploy unique search criteria based on their specific requirements. For example, a consumer can see the complete narrative history of an object or product in any possible views—limited, for instance, to publicly available information only. Conversely, an individual can explore the history of an object (i.e., sporting memorabilia) through associated narratives and recollections via a network of private databases. In other examples, a manufacturer can see the totality of details and attributes of all component materials, transportation, and pricing from the time of product inception. In similar examples, a pharmaceutical distributor can have access to the entire product lifecycle, including its effects on the SIO such as feelings, returns, side effects, propensity to purchase again, or a combination thereof. In some examples, the systems and methods described herein can integrate and use narrative history, product lifecycle, and associated technologies and processes.

Data may be referred to as “raw information” that can originate in any format, such as a recorded song, song lyrics, album art, promotional images, interviews, or a combination thereof. Information is any data that can be collected, formatted, digitized, produced, distributed, understood, deployed, and transmitted to the user/viewer/receiver. While the concept of information is exceptionally broad, it can include anything from personal narratives, stories, conversations, art literature, visual images, and multi-media.

Data processing can take place within a framework or system, divided into three distinct stages. First, data are collected, gathered, and/or input from various sources, such as retail locations, manufacturers, distributors, museums, educational organizations, service centers, sensors, and individuals. Second, data are sorted, organized, cleansed, and input into a digital repository, database, and/or system. Third, data are transformed into a suitable format that users can understand and use.

Quality data can be required for transformation into quality information. For instance, quality data must come from a reliable source (e.g., quality consistently exceeds a threshold), be complete without missing details, have systems in place to eliminate duplicated data, add relevance and value to the database to generate meaningful information, and be current and timely.

The systems and methods described herein can integrate multiple information types (e.g., collected, formatted, digitized, and/or distributed, or a combination thereof) and associated technologies and processes.

Examples of the systems and methods may relate to information as elements of a story or a story itself which may be an aggregation of information. When information is entered into and stored in an electronic database, it is generally referred to as data. After undergoing processing and retrieval techniques (e.g., associating attributes, characteristics, qualities, traits, elements, descriptors, and other associated data formatting) output data can then be perceived as uscable information and applied to enhance understanding of something or to do something.

In some examples, the systems and methods described herein can integrate multiple data types, determine quality of the data, and format the data. For example, using the systems and methods discussed herein, a system can utilize various data search view techniques in its system framework to access data and transform it into usable information. These include a holistic or comprehensive view, which refers to the complete data set “picture.” This view looks at the data throughout its entire lifecycle—from the moment an object originates until the information is needed by a manufacturer at the current moment of retrieval. An example of such a holistic view may outline a story, including data elements from multiple data sources, aggregated according to a common subject, theme, or query.

The holistic data approach is designed to improve data analysis and integration by enabling information to be distributed across multiple platforms and systems efficiently and consistently. The first component of the holistic data process includes data collection—assembling information from a variety of sources, both public and private. Data collection can be compiled and identified from structured, semi-structured, and unstructured sources, including operational systems (i.e., CRM, financial systems), website information, social media, and user-supplied narratives and stories.

The second component includes data integration and transformation, coalescing disparate data from multiple sources into an easily accessed and usable database(s). These integrated data and information assets provide the foundation for seamless and rapid access by end-users. Data integration and transformation rely on data quality, consistency, and control. The SIO solution provides processes that are repeatable, automated, and scalable to meet future user demand.

The third component includes presenting holistic data in a meaningful format(s) when requested, maintaining and supplementing data within a structural framework, increasing in value over time will remain a source of evolving relevance to users. Presentation techniques can uncover key metrics, trends, and exceptions and offer customized and unique visualizations.

The fourth component includes maintaining data quality and consistency is critical for the long-term viability of holistic data. SIO will deploy tactics including identifying data quality thresholds, fraud alerts, audit report functionality, and robust data governance protocols. All SIO master data repositories and data privacy strategies will be applied to all users.

The humanistic view of data or human-centric approach is intended to provide personalized experiences for the user, offering a revolutionary future for data visualization. Unlike the traditional methodology where questions are asked, and answers are found, the humanistic view of data is contextual or related to a specific object, circumstance, event, or relationship. Data views are transformed into visual representations in this process, adding considerable substance and context to the experience.

In some examples, the systems and methods described herein can integrate and use human-centric data technologies and processes. the SIO systems described herein leverage information from people with a personal connection to specific objects, events, and cultures. This human-centered approach to the origination, management, and interpretation of data provides value and importance for the people it came from and other people it will benefit from. This way, the SIO system can create a trusted relationship strengthened by transparency within its system framework. In some examples, the SIO system can implement a personal approach to how data are captured, analyzed, and displayed, realizing that subjectivity and context can play a defining role in understanding objects, events, social changes, and culture.

In some examples, the systems and methods described herein can integrate and use chronological/historical data views and timelines and associated technologies and processes. Chronological, historical, or timeline view data, broadly considered, is collected about past events and circumstances about a particular object, information set, or subject matter. Historical data includes most data generated manually or automatically and tracks data that changes or is added over time. Historical data offers a broad range of use possibilities relating to objects, narratives, cultural events, project and product documentation, conceptual, procedural, empirical, and/or objective information.

With increased cloud computing and storage capacities, data collection and retrieval allow for more data stored for greater periods with access by more users. Since data storage does require resources and maintenance, data life cycle management (DLM) can ensure that rarely referenced data can be archived and accessed only when needed.

Data preservation can provide users the ability to understand the past and a deeper understanding of the evolution of patterns and information over time, which provides insights and new perceptions about objects, events, and information. It further enables possible future assessments about cultures, aesthetics, symbols, social interaction, and systems. In addition, integrating the level of trust, truth, or reputation into the data preservation framework enhances the reliability and accuracy of historical data. Reputations and accuracy metrics for sources and content can guide users in distinguishing between well-established facts and less verified information, thereby bolstering the integrity of historical analysis and research. This integration can help enrich the depth of historical understanding and fortify the trustworthiness of the preserved data for future generations.

Historical data collections can originate from individuals using laptops, smartphones, tablets, or other connected devices. Data can be captured via smartphone cameras, collected via sensors, satellites and scanners, micro-chips, and massive arrays.

In some examples, the systems and methods described herein can integrate clustered view data technologies and processes. Data cluster view techniques are based on similarities among data points. Data clusters show which data points are closely related, so the data set can be structured, retrieved, analyzed, and understood more easily. Data clusters are a subset of a larger dataset in which each data point is closer to the cluster center than to other cluster centers in the dataset. Cluster “closeness” is determined by a process called cluster analysis. Data clusters can be complex or simple based on the number of variables in the group. Data clustering can be performed using a clustering algorithm, such as centroid-based clustering, distribution-based clustering, hierarchical clustering, K-means clustering, DB scan clustering, Gaussian mixture modeling, balance iterative reducing and clustering using hierarchies (BIRCH), affinity propagation clustering, means-shift clustering, ordering points to identify the clustering structure (OPTICS), agglomerative hierarchy clustering, or a combination thereof.

In some examples, clustered data sets can occur in abundance because all the events we experience and that we might wish to identify, understand, associate with specific objects and act upon have measurable durations. It, therefore, follows that the individual data points associated with each instance of such an event are clustered with respect to time. Many events associated with clustered data can be highly significant, and it is important to identify them as accurately as possible.

In some examples, clustering is deployed for high-performance computing. Since related data is stored together, the related data can be accessed more efficiently. Cluster views deliver two advantages: efficiency of information retrieval and reducing the amount of space required for digital storage. Information related and frequently requested is ideal for cluster viewed data requirements.

In some examples, the systems and methods described herein can integrate multiple data visual format technologies and processes. Data visualization is a methodology by which the data in raw format is portrayed to reveal a better understanding and provide a meaningful way of showcasing volumes of data and information. Various methods of data visualization and viewing options can be deployed for various purposes and information sets, including but not limited to biological views, legacy views, sentimental views, significance views, monetary/financial views, consumer views, supply chain views, and social views, and other views not yet imagined. For example, in supply chain, there is a need to create data visualizations that capture the connectedness of objects through time and space in relation to variables such as materials, timelines, locations on a map, companies and humans involved in the construction, consumption and delivery of such objects. Additionally, the system may be able to display the “story” that is created and understood when these elements are combined. In one example, the system may display these objects as data as a user would see in a readout visualization, or data extraction interface. In some examples, the system may display a view that shows the layers of connectedness and relationships of objects in a grid or other rich digital media display.

In some examples, the system that asks the “right questions” can generate information that forms the foundations of choosing the “right types” of visualization required. Presenting information and narratives into context for the viewer provides a powerful technique that leads to a deeper understanding, meaning, and perspective of the information being presented. A clear understanding of the audience can influence the visualization format types and create a tangible connection with the viewer. Every data visualization format and narrative may be different, and visualization types may be customized based on goals, aims, objects, or topics.

In some examples, the systems and methods described herein can integrate hierarchical database models, technologies, and processes. A hierarchical data view is defined as a set of data items related to each other by categorized relationships and linked to each other in parent-child relationships in an overall “family tree” structure. When information needs to be retrieved, the whole tree is scanned from the root node down. Modern databases have evolved to include the usage of multiple hierarchies over the same data for faster, easier searching and retrieval.

The hierarchical structure of data is important as the process of data input, processing, retrieval, and maintenance is an essential consideration. An example would include a catalog of products, each within specific categories. Categories could be high-level categories such as clothing, toys, appliances, and sporting goods—however, there may also contain subcategories within those: in clothing, there may be pants, jackets, shoes—toys might include board games, action figures, and dolls. Within subcategories, there may be even more categories and so on.

In some examples, the systems and methods described herein can integrate spherical data views and data credibility control technologies and processes. A spherical data view is a form of non-linear data in which observational data are modeled by a non-linear combination model relying on one or more independent variables. Non-linear methods typically involve applying some type of transformation to the input dataset. After the transformation, many techniques can then try to use a linear method for classification.

In some examples, data credibility is a major focus implemented to ensure that databases function properly and return quality data and accurate information to the user. In the SIO system, a weighted average technique of ensuring data quality can be utilized and includes processing a collection of each of the data attributes such as location, type of device, history, individual, current, and/or past relationships with other SIOs and many others to determine the credibility of the SIO data. For example, a search for a product grown in a certain location by a specific farm might include information relating to climate, seed varietal, farm name, sustainable price, location, compliance with regulations, and organic certification. This process evaluates the average of a data set, recognizing (i.e., weighing) certain information as more important than others.

Verifying data integrity is an extremely important measure since it establishes a level of trust a user can assign to the information returned and presented. Credible data can only be assured when robust data management and governance are incorporated into the system. Satisfying the requirements of intended users and associated applications will assure the highest quality data, including but not limited to accuracy from data input through data presentation, exceptional database design and definition to avoid duplicate data and source verification, data governance and control, accurate data modeling and auditing, enforcement of data integrity, integration of data lineage and traceability, quality assurance and control, or a combination thereof.

In some examples, the systems and methods described herein can integrate computer programming and blockchain technologies and processes. A blockchain framework provides a unique data structure in the context of computer programming, consisting of a network of databases/virtual servers connected via many distinct user devices. Whenever a contributor in a blockchain adds data (i.e., a transaction, record, text, or a combination thereof), it creates a new “block,” which is stored sequentially, thereby creating the “chain.” Blockchain technology enables each device to verify every modification of the blockchain, becoming part of the database and creating an exceptionally strong verification process.

Security provided by this distributed ledger/data process is among the most powerful features of blockchain technology. Since each device holds a copy of these ledgers, the system is extremely difficult to hack—if an altered block is submitted on the chain, the hash or the keys along the chain are changed. The blockchain provides a secure environment for sharing data and is increasingly used in many industries, including finance, healthcare, and government.

Blockchains are typically divided into three distinct types and can be managed differently by the network participants. For instance, blockchain ledger implementations can include (1) public blockchain ledgers, (2) private blockchain ledgers, and (3) hybrid blockchain ledgers. Public blockchain ledgers are open to a wide range of users where anyone can join a network and are by design “decentralized systems” where participants can read, add entries, and participate in processes. Public blockchains are not controlled by any one party. Private blockchains are open to a limited number of people and are typically used in a business environment where the content in the blockchain is not shared with the public and can be controlled by one or more parties. A hybrid blockchain implementation is a mixture of private and public blockchains that, in some examples, is not open to everyone but still offers music data integrity, transparency, and security features that are novel components of the technology. Blockchain technologies offer increased security and can accommodate highly scalable applications.

In some examples, the systems and methods described herein can integrate non-fungible tokens (NFT). Blockchain security and cryptographic protocols make this technology increasingly attractive for business models and applications where provenance and authenticity are critical. While blockchain is well-known for applications in the cryptocurrency world, it is becoming an essential component of applications for NFT.

If something is fungible—it is interchangeable with an identical item—NFTs, on the other hand, are unique and non-interchangeable units of data stored on a blockchain—therefore, one NFT is not equal to another. NFTs are usually associated with reproducible digital files such as photos, artwork, historical objects, narratives, videos, and audio. The possibilities for NFT's within the blockchain framework are virtually endless because each NET is unique yet can evolve over time. The value of NFTs is in their “uniqueness” and ability to represent physical objects in the digital world.

Once an NFT is created, it is assigned a unique identifier that assures authenticity and originality. Each NFT is unique, so all the information about the token is stored on the blockchain—meaning if one “block” in the chain fails, information will still exist on another block, ensuring the NFT remains safe and secure indefinitely.

The unique capabilities of blockchain technology coupled with NFT's guarantee the authenticity, originality, and longevity of objects, artwork, cultural items, and music tracks, among a host of other categories. With blockchain technology, it is impossible to copy or reproduce an NFT, and ownership can be recorded unalterably (or a way in which alteration(s) are detectable).

Tracking and exchanging real-world assets in the blockchain can ensure that the asset has not been duplicated or fraudulently altered. NFT's are not limited to purely digital items, but digital versions of objects from the physical world can be attached to specific narratives and stories. Unlike digital media, represented by codes and numbers—physical objects are separate entities that can carry intuitive connections.

Human memories can be connected to a physical object providing meaning and context for the viewer. For examples, a toy may be linked with a story that can transport the viewer back to a childhood experience—not necessarily connected to any monetary value but a narrative memory wrapped within the object itself. In other examples, narratives can be associated with anything, from a book of recipes passed from one generation to the next or table favors from a wedding.

One example of the systems and methods described herein can occur in cultural heritage preservation. Collecting and preserving cultural heritage data, objects, and associated narratives allow communities to interact with historical and culturally relevant artifacts and objects in unique and novel ways. These objects communicate with the viewer through the memories we associate with them. Global historical events and objects are inextricably linked to personal histories.

Internet connectivity allows “connected objects” to be more useful and interactive in conjunction with the use of enhanced programming platforms, sensors, AI, Augmented reality, intuitive applications. The power to connect stories and narratives with objects, and share the resulting combination, helps share information and stories efficiently and flexibly. “Historocity” or “Historacity,” as defined herein, is a specialized metric designed to quantify the aggregated historical value of an artifact, or a collection thereof. Unlike the traditional concept of historicity, which is limited to the verification and authentication of historical events, characters, or phenomena, Historocity expands the scope to include three additional dimensions: popularity, trust or certification, and value associated with objects. Popularity is measured by the level of public attention an artifact or its associated elements have garnered over time, through public mentions, scholarly references, or social interactions. Trust or certification quantifies the level of confidence in the provenance or authenticity of the artifact, established through expert opinions, credentials, or documented evidence. The value associated with objects allows for comparison of other similar objects across many domains, monetary value being the most obvious. For example, two nearly identical baseballs may sell for entirely different orders of magnitude based on the stories told about them, e.g., a slightly used baseball may sell at a yard sale for $2 after a member of the household has lost interest in the sport, compared to Mark McGwire's No. 70 in 1998 baseball, which sold for $3 million. The calculation of Historocity integrates these multidimensional data points to produce a composite value that can be represented numerically or categorically. In some instances, this value is further refined by integrating social or sentimental factors, yielding an even more comprehensive value termed “Aggregated Historocity.” This aggregated value not only serves as a holistic measure of the artifact's historical significance but also holds transactional utility. It can be sold, transferred, willed, or loaned either independently of the physical artifact or in conjunction with it. Historocity provides a robust framework for evaluating the comprehensive historical significance of artifacts and collections, offering utility for curators, researchers, and collectors alike.

The SIO and their associated Historocity scoring system present a method of determining an object's significance based on a combination of various value systems. Throughout history and across cultures, value systems have continuously evolved to shape human beliefs, behaviors, and decision-making processes. For instance, the perception of time has been universally regarded as a treasured resource, prompting individuals to focus on punctuality and efficiency. Similarly, the value attached to money, and its cultural derivatives like currency, signifies the emphasis on financial stability and prosperity. While these tangible assets possess clear worth, abstract concepts like social and relationship values underscore the importance of interpersonal connections, community bonds, and societal contributions. Historical values emphasize the reverence for past lessons, traditions, and inheritances, whereas personal and intrapersonal values reflect an individual's internal beliefs about self-worth, growth, and potential. Objects can also carry sentimental value, representing emotional bonds, memories, or significant life moments. Spiritual systems provide perspectives on existential beliefs and moral codes, influencing one's view on life's purpose and ethical considerations. Furthermore, in an era of growing environmental consciousness, the significance of preserving our natural surroundings is reflected in environmental values. Lastly, educational value, focusing on the efficacy and relevance of learning experiences, emphasizes the importance of knowledge acquisition and cognitive development. By integrating these multifaceted value systems into the Historocity scoring, the SIO offers a comprehensive, nuanced, and culturally sensitive method to ascertain an object's importance in a given context.

To further expand on the Historocity scoring system in the SIO, other value systems may be considered. Incorporation of emotional value addresses the complex spectrum of human feelings attached to objects or experiences. This encompasses not only positive sentiments like joy and nostalgia but also accounts for potential negative associations. Understanding that our connections with items aren't merely functional but deeply emotional provides a holistic view of an object's significance. Location value accentuates the importance of geographical positioning in determining an object's relevance. Economic and social attributes of a location, combined with factors like access to essential amenities and safety, play a pivotal role in an object's value. This dimension not only provides context but also highlights the dynamic interplay of market forces and socio-economic conditions in shaping perceptions of value. Intrinsic value incorporates a philosophical perspective of the value of an object, emphasizing the inherent worth of an object or entity, irrespective of its market-driven or functional value, this may be especially true when considering human life or other fundamental human values. This provides the concept that certain objects, beings, or environments possess value purely based on their existence or innate qualities outside of any other value system. Spatial value can be considered in terms of, for example, urban planning and architecture, stressing the value derived from specific spatial contexts, e.g., a certain amount of square or cubic footage may have some value regardless of (or despite) its contents. This could be an urban park or a historical site. The worth isn't just aesthetic but also pertains to economic implications, functionality, and broader urban development strategies. Physical value may be tangible metrics on the material properties and performance capabilities of objects.

In some examples, the Historocity scoring system of the SIO may further incorporate or reflect upon various additional value paradigms, including Fiat value, underpinned by government regulation and policy, remains contingent upon macroeconomic trends, political stability, and regulatory decisions, rendering its value both influential and volatile. Conversely, the cryptocurrency value, powered by cryptographic technology such as blockchain, is anchored in decentralized systems and garners its worth from technological trust and its potential to redefine financial structures. Driven by market sentiments, technological evolutions, and regulatory climates, its fluidity mirrors the dynamic nature of digital asset valuation. The intellectual value of a thought or idea can be both palpable, evidenced by technical breakthroughs, and intangible, manifesting as sources of intellectual or aesthetic stimulations. These thoughts, influenced by sociocultural dynamics, remain transformative to societies. Adjacently, copyright value provides protection to the value created by creativity and innovation, offering both economic rights and a moral stance to creators. Through licensing and intellectual property management, this value protects and incentivizes originality.

In some examples, a Historocity scoring system can incorporate a myriad of value systems, such as, for example human value, which emphasizes the innate worth of every individual, highlighting the significance of human rights, social justice, and overall well-being. Such a system promotes respect, autonomy, and the holistic growth of each individual, free from discrimination. Sustainability value underscores the importance of sustainable practices that balance economic, social, and environmental considerations. The objective of such a value system is to optimize present needs without jeopardizing future generations, emphasizing the reduction of environmental footprints and promoting sustainable development. Business value offers a perspective on the significance of a company's contributions to stakeholders, quantified through financial metrics, market presence, and societal impact. Economic value provides ways to evaluate the worth of goods, services, or assets in a market setting. Self-value emphasizes the inherent worth and self-perception an individual possesses, reflecting on their mental well-being and overall life satisfaction. It is intrinsically linked to one's self-image, confidence, and overall life outcomes.

Environmental value emphasizes the significance of preserving and valuing the natural environment. Instrumental value provides an estimate of the tangible benefits derived from the environment, signifying the interconnectedness between human well-being and environmental health. Health value focuses on the importance of physical and mental health, which is fundamental for individual well-being and societal progress.

In the SIO network, a Historocity scoring system is introduced to facilitate the exploration and ranking of individual objects and collections. The system computes relative scoring metrics based on multiple value systems, both mentioned and unmentioned. Users can evaluate and order objects or collections in accordance with these metrics, providing flexibility to accommodate any past, present, or future value system for comprehensive object assessment.

Some illustrative and non-limiting examples of this disclosure, illustrating its features, are discussed in detail with respect to the figures. It can be understood that the examples are intended to be open-ended in that an item or items used in the examples is not meant to be an exhaustive listing of such items or items or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of examples, only some exemplary systems and methods are now described.

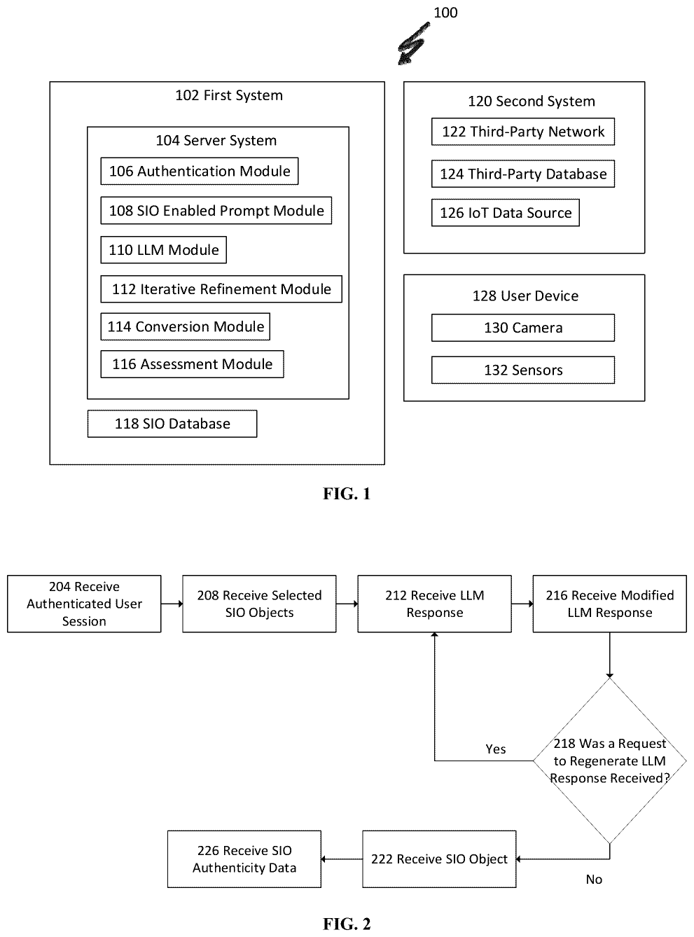

FIG. 1 is a block diagram illustrating an architecture of an object generation and trust assessment system 100, according to some examples. This system comprises of a first system 102 that may collect and store an SIO. The first system 102 enables instantiation of SIO data for each object in the system, and recommends data based on time, place, space, written tags, photos, videos, descriptions, commonality, and emotions to be displayed through an interface, among other functions.

The first system 102 may further be used to assess and verify the accuracy of an object or story which may be comprised of one or more objects. Truth may be based upon verifiable facts, or by corroborating one or more objects with one or more similar or verifiable accounts. For example, a plurality of accounts may describe the series of events during a baseball game. While the perspectives of each account may vary, some common elements can be corroborated such as the teams and players involved, the location and time of the game, the weather during the game, the plays which occurred, or a combination thereof. In some examples, verifying common details may provide confidence that the source of the data is trustworthy and therefore their account can be trusted. By contrast, if elements of an individual's account conflicts with the majority of other accounts, then the individual may be deemed less trustworthy, and therefore their story may not be trusted. A first system 102 may additionally aggregate data, such as data about human history, and upon selection of one or more parameters, may generate a story comprised of one or more relevant accounts of subjects, events, and/or locations which may then be structured, such as in the chronological order of events, or as locations and/or features as a map, before being presented to a user.

The server system 104 initiates an authentication module 106 which creates an authenticated session for a user of a first system 102 and may additionally prompt a user to create a new user account if one does not exist on the first system 102. An authentication session is received from the authentication module 106 and the SIO enabled prompt module 108 is initiated which receives user data and retrieves SIO objects from an SIO database 118 which are displayed to a user via a user device 128 and from which the user may select one or more SIO objects. The selected SIO objects are received and the LLM module 110 is initialized which allows an LLM to be selected, configured, and allows a prompt to be generated, modified, and submitted to the selected LLM to generate an LLM response. The LLM response is received from the LLM module 110 and the iterative refinement module 112 which receives an LLM response and selected SIO objects and allows a user to provide data to directly or indirectly modify the LLM response. A modified LLM response is received and if the modified LLM response includes a request to regenerate part or all of the LLM response, initialize the LLM module 110 to generate a new LLM response, otherwise initiate the conversion module 114 which receives the modified LLM response, validates the LLM response, and converts the LLM response into an SIO data structure. A unique SIO identifier is created, and additional SIO object and user associations may be made with the new SIO data object. The SIO data object is received and the assessment module 116 is initiated which receives an SIO object and identifies associated SIO objects and user data, accesses SIO trust scores for the SIO objects and users and determines the authenticity of the SIO object. The SIO object generation process ends.

Additionally, the authentication module 106 receives user data comprising at least a unique identifier and authentication data and the provided user data is verified against data in an SIO database 118. If the user is not authenticated, the user is prompted to create a new SIO user account, otherwise an authentication token is generated, and a user session is initialized. The authenticated user session is sent to the server system 104. The SIO enabled prompt module 108 receives user data such as a search query from which an SIO search query is generated and used to query an SIO database 118. The SIO data from the SIO database 118 is displayed to the user via a user device 128 and one or more SIO objects are selected. Additional queries may be performed prior to sending the data back to the server system 104. The LLM module 110 receives selected SIO objects and an LLM is selected. A prompt is generated and validated for the selected LLM, and if valid, the LLM parameters may be optionally configured and submitted to the LLM. If the prompt is not valid, a new prompt is generated and validated until a valid prompt is generated. An LLM response is received from the LLM which is sent to the server system 104. The iterative refinement module 112 receives an LLM response and selected SIO objects which are used to query an SIO database 118 for SIO data relating to the LLM response and selected SIO objects. User input is received via a user device 128 which may be used to directly or indirectly modify the LLM response.

In some examples, the modified LLM response may comprise a request to regenerate part or all of the LLM response. The modified LLM response is sent to the server system 104. The conversion module 114 receives an optionally modified LLM response and validates the LLM response for compatibility with an SIO data structure. In some examples, required data elements mission from the LLM response may be replaced with a default value, may be populated with data generated by an LLM or other algorithm, or a user may be prompted via a user device 128 to review and/or provide data to ensure the LLM response contains all required data needed to convert the LLM response to an SIO data structure. Next, the LLM response is converted to an SIO data structure and a unique SIO identifier and object associations are generated which may include user association and/or permissions. The SIO data object is saved to an SIO database 118 and is sent to the server system 104. The assessment module 116 receives an SIO object, identifies associated SIO objects and user data, and then accesses SIO trust data related to the associated SIOs and/or users. The received SIO object's authenticity is verified using the associated SIO objects, and SIO object and user trust data to determine an authenticity score or other form of authenticity data. The authenticity data is saved to an SIO database 118 and is sent to the server system 104. Then, the SIO database 118 stores data within a first system 102.

In some examples, the data may comprise at least a plurality of objects and attributes describing an SIO. A social identity may comprise aggregated data from a plurality of sources which may include objective, factual data, or subjective accounts relating to the object. For example, accounts may comprise a roster of a baseball game in which Babe Ruth played and a list of equipment utilized during the game including baseball bats. The SIO database 118 may further comprise a trust score or other indication of a level of trustworthiness, reliability, or accuracy of each SIO object and/or users associated with each SIO object.

A second system 120 is a distributed network of computational and data storage resources which may be available via the internet or by a local network. A second system 120 accessible via the internet is generally referred to as a public cloud whereas a second system 120 on a local network is generally referred to as a private cloud. A second system 120 may further be protected by encrypting data and requiring user authentication prior to accessing its resources. A third-party network 122 is comprised of one or more network resources owned by another party. For example, a third-party network 122 may refer to a service provider, such as those providing social networks such as Facebook or Twitter. Alternatively, a third-party network 122 may refer to a news website or publication, a weather station, or a combination thereof. A third-party network 122 may further refer to a service provider for large language models, such as Microsoft, Google, or Open AI. A third-party database 124 stores data owned by another party. For example, a third-party database 124 may store data on a third-party network 122, or may alternatively comprise archival data, historical accounts, survey results, customer feedback, social media posts, or a combination thereof. In one example, a third-party database 124 may include, for example, a repository of people, objects, events, and related statistics related to professional baseball games, such as may be maintained by Major League Baseball (MLB) or an affiliate organization. In an alternate example, a third-party database 124 may comprise discography data related to the performance and recording history of Carlos Santana stored in a music production database. An IoT (Internet of Things) data source 126 is an internet connected device which may comprise one or more sensors or other sources of data. IoT data sources 126 may comprise appliances, machines, and other devices, often operating independently, which may access data via the internet, a second system 120, or which may provide data to one or more internet connected devices or a second system 120.

A user device 128 is a computing device which may comprise any of a mobile phone, tablet, personal computer, smart glasses, audio, or video recorder, or a combination thereof. In some examples, a user device 128 may include or be comprised of a virtual assistant. In other examples, a user device may comprise one or more cameras 130 and/or sensors 132. A user device 128 may comprise a user interface for receiving data inputs from a user. In some examples, a user interface may be a touch screen or mouse and keyboard input for a user device 128. In other examples, a user interface may be a microphone input and may further be paired with one or more speakers to enable bidirectional audio communication. A camera 130 is an imaging device or sensor 132 which collects an array of light measurements which can be used to create an image. One or more measurements within the array of measurements can represent a pixel. In some examples, multiple measurements are averaged together to determine the value(s) to represent one pixel. In other examples, one measurement may be used to populate multiple pixels. The number of pixels depends on the resolution of the sensor 132, comprising the dimensions of the array of measurements, or the resolution of the resulting image. The resolution of the camera 130 sensor 132 does not need to be the same as the resolution of the resulting image. A camera 130 may be a component in a user device 128 such as a mobile phone, or alternatively may be a standalone device. In some examples, a camera 130 may be analog, where an image is imprinted on a film or other medium instead of measured as an array of light values. A sensor 132 is a measurement device for quantifying at least one physical characteristic such as temperature, acceleration, orientation, sound level, light intensity, force, capacitance, or a combination thereof. A sensor 132 may be integrated into a user device 128, such as an accelerometer in a mobile phone, or may be a standalone device. A sensor 132 may also be found in an IoT data source 126 or a third-party network 122.

FIG. 2 is a flow diagram illustrating a process generating and authenticating SIO data, according to some examples.

At operation 204, the server system 104 receives an authenticated user session from the authentication module 106. To receive the authenticated user session, the authentication module 106 is initiated. The authentication module 106 receives at least a unique identifier and authentication data from a user via a user device 128 and verifies the data provided by the user against data stored in the first system 102 to verify that the user exists and that the provided authentication data matches the corresponding authentication data stored in the first system 102. The authenticated user session may comprise an authentication token, user device 128 ID, and an activity timer status. In some examples, the authentication module 106 may continuously run in parallel with other modules to verify the validity of the current user session and may invalidate the user's authentication token and end the user session if, for example, the activity timer exceeds a threshold, and the authentication token is revoked, and the user session is terminated.

At operation 208, the server system 104 receives one or more selected SIO objects from the SIO enabled prompt module 108. To receive the one or more selected SIO objects, the SIO enabled prompt module 108 is initiated. The SIO enabled prompt module 108 receives data from a user device 128 and generates one or more SIO search queries which are used to query an SIO database 118. The results are displayed to a user via a user device 128 and one or more SIO objects may be selected. If additional SIO queries are required, the process is repeated. In one example, the SIO object relating to baseball bats used by professional baseball players, and SIO objects relating to Babe Ruth.

At operation 212, the server system 104 receives an LLM response from the LLM module 110. To receive the LLM response, the LLM module 110 is initiated. The LLM module receives selected SIO objects and selects an LLM. An LLM prompt is generated based upon the selected SIO objects and the prompt is optionally validated. If the prompt is invalid, it is regenerated until a generated prompt is valid. LLM parameters may further be optionally configured and the prompt and/or LLM parameters may be submitted to the LLM. A response is received from the LLM. The LLM response may comprise any of generated text, tables, diagrams, figures, images, or a combination thereof. In an example, the LLM comprises a story about Babe Ruth hitting a home run using a baseball ball bat in possession of the user.

At operation 216, the server system 104 receives a modified LLM response from the iterative refinement module 112. To receive the modified LLM response, the iterative refinement module 112 is initiated. The iterative refinement module 112 receives an LLM response and selected SIO objects and queries an SIO database 118 for additional data relating to the LLM response and/or selected SIO objects. The LLM response and SIO data are displayed to a user via a user device 128 and the user may optionally provide additional data to be used to modify the LLM response, either directly or indirectly. The modified LLM response may comprise an LLM response which was modified directly or indirectly based upon a user's input. In some examples, the modified LLM response may be the same as the original LLM response. In other examples, the modified LLM response may comprise a request to regenerate part or all of the LLM response. In such examples, the modified LLM response may further comprise data and/or instructions to be used to modify the LLM prompt to generate a new LLM response.

At operation 218, the server system determines whether a request to regenerate the LLM response was received. A request to regenerate the LLM response may have been received if the user indicated that at least part of the LLM response should be regenerated as part of the modified LLM response received from the iterative refinement module 112. If a request to regenerate the LLM response was received, return to operation 210 and initialize the LLM module 110.

At operation 222, the server system 104 receives an SIO object from the conversion module 114. To receive the SIO object, the conversion module 114 is initiated. The conversion module 114 receives a modified LLM response which may or may not have been modified from its original content by a user which is then validated for compatibility before being converted into an SIO data structure. A unique SIO identifier is created and may further be associated with a user and associations with other SIO objects are generated. The SIO data is saved to an SIO database 118. The SIO object having been generated from a modified LLM response and the SIO object optionally having associations with other SIO objects.

At operation 226, the server system receives SIO authenticity data for the SIO object from the assessment module 116. To receive the SIO authenticity data, the assessment module 116 is initiated. The assessment module 116 receives an SIO object and identifies associated SIO objects and associated user data. SIO trust scores are accessed for each associated SIO object and/or user. The SIO trust scores are used to evaluate the authenticity of the SIO object, and the authenticity data generated for the SIO object is saved to the SIO database 118. In an example, the SIO authenticity data comprises a trust score of 78. In another example, the authentication data comprises a binary assessment of authenticity. The authentication data may additionally comprise a qualitative indication that the authentication method utilized was an automated comparison of SIO object data and an aggregation of trust scores. Then, the SIO object generation ends.

FIG. 3 is a flow diagram illustrating a process performed by authentication module 106, according to some examples.

At operation 302, the authentication module 106 receives user data from a user device 128. In some examples, the user data may comprise any of a unique identifier such as a username, user ID, email address, or a combination thereof, and a form of authentication such as a password, biometric, identification card, or a combination thereof.

At operation 304, the authentication module 106 verifies the provided user data and determining whether the user is authorized to access a first system 102. Verifying the user may comprise looking up the data provided by the user and determining whether the user exists and further confirming whether the provided authentication data matches the authentication data in a database and/or first system 102. In some examples, the stored authentication data may be encrypted and stored as a hash, and therefore matching the provided authentication data may comprise encrypting the provided authentication data and comparing the resulting hash to the stored hash value.

At operation 306, the authentication module 106 determines whether the user is authenticated. In some examples, the user is authenticated if the user exists in the database and/or first system 102 and the provided authentication data is verified. If the user exists and the authentication data can be verified, the user is authenticated, and an authentication token may be generated for the user's session. In an example, the user may be determined to not exist if the provided identifying data, such as a username, user ID, email address, or a combination thereof, does not match the corresponding unique identifier within a database and/or first system 102.

At operation 308, the authentication module 106 prompts the user to create a new SIO user account if the user cannot be authenticated. In some examples, the user may not be authenticated due to the provided authentication data not matching the authentication stored in a database and/or in the first system 102. In other examples, the user may not exist in a database and/or in the first system 102. The user may be prompted to provide a unique identifier such as a username, user ID, email address, or a combination thereof, and a form of authentication such as a password, biometric, identification card, or a combination thereof, to be used to authenticate the user when accessing the first system 102.

At operation 310, the authentication module 106 generates an authentication token for the user's session if the user is authenticated. An authentication token can be a browser cookie or JSON web token, generated to manage the user's authentication state. In some examples, the authentication token may be stored on a user device 128 and may be accessed by a web browser, server, or first system 102, to verify the authentication status of the user device 128. In some examples, authentication tokens may expire after a predetermined amount of time, after a period of inactivity, or if the user ends the session, such as by signing out, closing the application and/or browser.

At operation 312, the authentication module 106 retrieves user roles and permissions from a database and/or the first system 102. User roles may comprise any of general user, moderator, administrator, or a combination thereof. Permissions may vary based upon the user role, and the user and their relationship with one or more SIOs. For example, a general user may only have permission to access publicly accessible SIOs or private SIOs with which they are responsible for or associated with. Likewise, a general user may only edit public or private SIOs with which they are responsible for or which they have been granted permission to edit. An administrator may have limited access to all SIOs or may have a more limited scope. Likewise, moderators may be granted permission to flag, and temporarily hide or remove SIO records.

At operation 314, the authentication module 106 initializes the user's session. The session may be initialized by logging the current authentication token and beginning an activity timer. When the activity token indicates that the user has been idle for a period of time greater than a threshold value, such as 15 minutes, the session may be terminated, requiring a new authentication token. Likewise, an identifier associated with the user device 128 may be stored with the authentication token to prevent use of the authentication token with a different user device 128.

At operation 316, the authentication module 106 sends the authenticated user session to the server system 104. The authenticated user session may comprise an authentication token, user device 128 ID, and/or a current activity timer state.

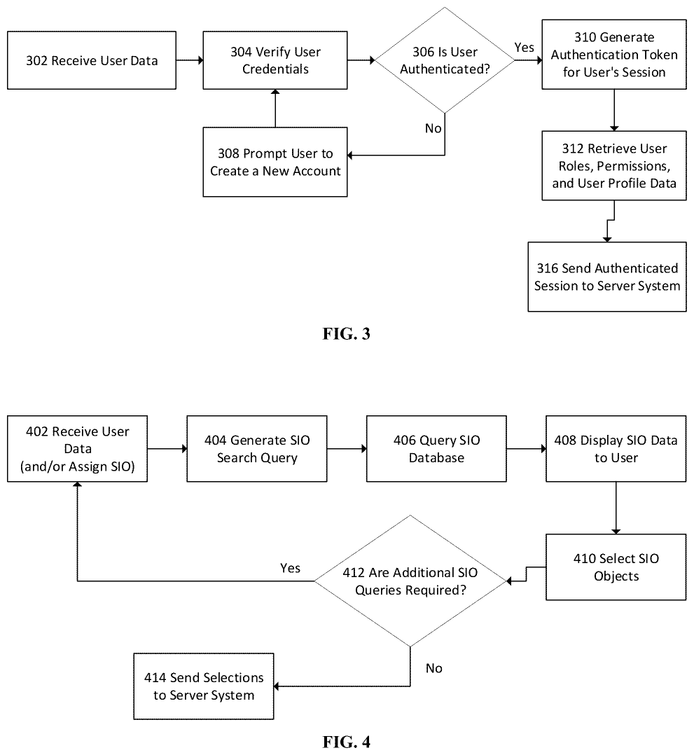

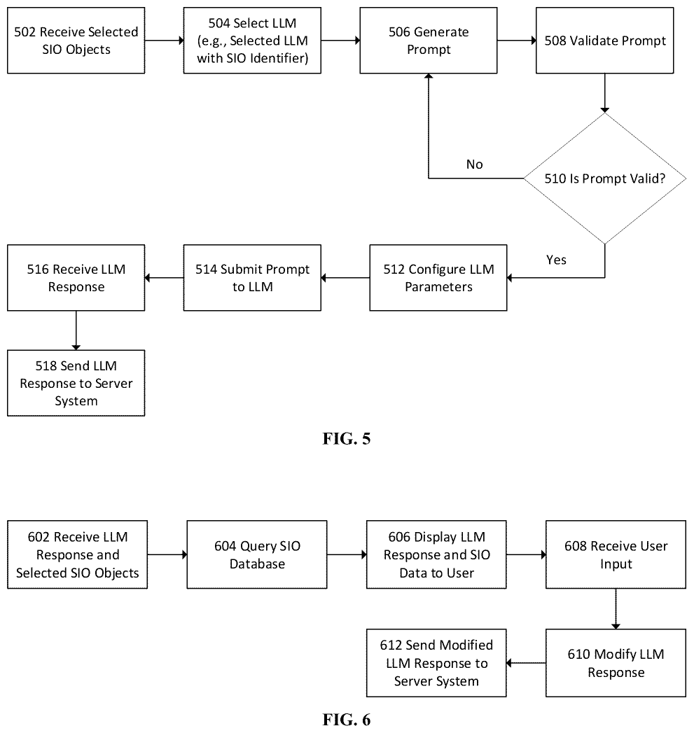

FIG. 4 is a flow diagram illustrating a process performed by SIO enabled prompt module 108, according to some examples.

At operation 402, the SIO enabled prompt module 108 receives user data comprising a search query. For example, the user data may comprise a description of a car, which may include the make, model, year, and may further comprise additional details such as color, unique features, such as customizations, damage, or a combination thereof. Additional information provided by the user may include owner history, events related to the vehicle, or a combination thereof. In another example, the user data may comprise the description of a baseball bat used by a specific baseball player, such as Babe Ruth, and may further comprise a description of a specific game, such as the teams playing, location the game was played, other players or participants, such as coaching staff, announcers, umpires, or a combination thereof, and may further comprise one or more attendees who may have attended, or a combination thereof. In an example, the user data describes a baseball bat used by Babe Ruth that is in the user's possession.

At operation 404, the SIO enabled prompt module 108 generates an SIO query. In some examples, an SIO query can be a search query in a format which may allow the query of an SIO database 118. In some examples, an SIO query may comprise an SQL query. In other examples, the SIO query may comprise a proprietary query syntax. In other examples, the SIO query may comprise one or more hashes based upon the provided user data to facilitate the lookup of the SIO data in the SIO database 118. In another example, the SIO query may comprise one or more tokens which may facilitate the lookup of data in a vector database which may comprise the SIO database 118 or which may be generated based upon data stored in the SIO database. In some examples, a plurality of SIO queries may be generated. In such examples, the SIO queries may comprise varying levels of specificity, such that if a more restrictive search yields few or no results, a more generalized search may be executed.

At operation 406, the SIO enabled prompt module 108 queries the SIO database using the generated SIO query. The query returns one or more SIO objects matching, related to, or similar to the SIO query. In some examples, the SIO query may return no results. In such examples, the user may be prompted to refine their search query, such as by adding or removing descriptive terms. Alternatively, filters selected by the user may be removed. In some examples, if no results are returned by the generated SIO query, restrictive filters and/or descriptive terms may be sequentially removed from the SIO query until a result is returned. In some examples, the SIO query may comprise a plurality of queries which may comprise varying levels of specificity. In such examples, results from a more restrictive search may be ranked higher than results of more general searches. In an example, query the SIO database for SIO objects relating to baseball bats used by Babe Ruth during professional baseball games.

At operation 408, the SIO enabled prompt module 108 displays the SIO data from the SIO database 118 returned by the generated SIO query to the user via a user device 128. The SIO data may comprise one or more SIO objects. In some examples, the SIO query may return no results. In such examples, the user may be prompted to refine their search query, such as by adding or removing descriptive terms. The SIO objects may be displayed in order of a rank, which may indicate the relevance of the SIO object to the search query.

At operation 410, the SIO enabled prompt module 108 selects one or more SIO objects from the results displayed to the user. In some examples, the user may provide additional information, such as relationships between one or more selected SIO objects. The user may also provide additional descriptions based upon the user's own knowledge and experience. In an example, the user selecting SIO objects comprising at bats by Babe Ruth in games played against the Chicago White Sox.

At operation 412, the SIO enabled prompt module 108 determines whether additional queries of an SIO database 118 are required. In some examples, the user may indicate whether they want to perform additional queries. If additional queries are required, the SIO enabled prompt module 108 may return to operation 402 and receive new or additional user data.

At operation 414, the SIO enabled prompt module 108 sends the SIO selections to the server system 104 if no additional SIO queries are required.

FIG. 5 is a flow diagram illustrating a process performed by LLM module 110, according to some examples.

At operation 502, the LLM module 110 receives one or more selected SIO object from the server system 104. In an example, the selected SIO objects comprise data related to at bats by Babe Ruth in games against the Chicago White Sox. The SIO objects comprise bats used by Babe Ruth, pitchers, coaches, players involved in plays, the locations where games were played, or a combination thereof.

At operation 504, the LLM module 110 selects a large language model (LLM) from one or more selected LLMs. Examples of LLMs may include proprietary models such as OpenAI's ChatGPT, Google's Bard, or Microsoft's Bing Chat, or open-source models such as Vicuna or Meta's LLAMA 2. An LLM may comprise a vector database and/or an API facilitating queries, often in the form of prompts, to the LLM which tokenizes the prompt and uses the data in the vector database to determine an appropriate output.

At operation 506, the LLM module 110 generates a prompt or query using the one or more selected SIO objects. In some examples, the generated prompt may be in the form of a conversational question and may utilize generative natural language processing. In other examples, the prompt may be provided by a user. In other examples, the prompt may comprise a structured query utilizing a syntax compatible with the selected LLM. In an example, a prompt may be “Generate a story about the game where this baseball bat was used by Babe Ruth in a game against the Chicago White Sox.” Alternatively, the prompt may be “Generate an image of Babe Ruth using this bat in a game against the Chicago White Sox.” In some examples, additional data may be provided by the user, such as an image of the baseball bat in the user's possession. In some examples, operation 506 may address the need for filtering content based on user preferences, especially in cases involving anonymous contributions, the LLM module 110 includes means for configuring user-defined filters. These filters allow users to specify parameters such as anonymous content, hate speech, profanity, and any other undesirable content. This functionality not only caters to users seeking a customized experience but also aligns with the evolving norms of digital content consumption, where users exercise greater control over the information they access. For instance, users can opt to view only content that has been verified or has a certain level of trust and reputation, thus ensuring that they are interacting with reliable and contextually appropriate information. This feature also supports LLMs in effectively categorizing and presenting content that aligns with the users' set preferences and values. In a further example, a community of users may be allowed to comment on content, either pointing to a source that invalidates the content or otherwise clarifying the context of the content for future users who view the content. This may provide means for providing users with highly reputable information from a variety of sources and viewpoints without the need to actively moderate or censor content.

At operation 508, the LLM module 110 validates the provided prompt. For example, if the selected LLM requires a structured query syntax, verifying the generated prompt matches the required syntax. Alternatively, validating the prompt may comprise comparing the prompt to the selected SIO object and confirming that one or more of the selected SIO objects are included in the prompt. In other examples, the prompt may be validated by a user confirming that the generated prompt contains the selected SIO objects and any other information as desired by the user. In an example, validation of the prompt may comprise tokenizing the prompt and verifying the length of the tokenized prompt and that it does not exceed the maximum length allowed by the LLM. In another example, the prompt may be validated by confirming that if a picture is referenced that a source photo is provided, or a reference is provided to allow access to the required photo. In other examples, validating the prompt may include prompting the user for additional data.

At operation 510, the LLM module 110 determines if the generated prompt is valid. The prompt is valid if it is in the format required by the selected LLM. The prompt may further require that the generated prompt contains at least one selected SIO object and/or meets the user's requirements. In an example, the prompt is valid if the context length, or length of the tokenized prompt is less than the maximum allowable by the LLM. If the prompt is not valid, return to operation 506 and generate another prompt. In an example, the prompt is not valid because it is missing data, such as a referenced photo. In another example, the prompt is not valid because the maximum context length of the selected LLM is 4,000 tokens, and the generated prompt is 4,235 tokens.

At operation 512, the LLM module 110 configures the LLM parameters for the LLM. Examples of LLM parameters may include any of temperature, or level of creativity the LLM should utilize, maximum number of tokens to utilize and/or generate, any may further comprise parameters such as custom data to be referenced by the LLM, such as a third party database 124, a website, uploaded file, or a combination thereof. In an example, the temperature is 0.8, and the maximum number of response tokens is 2,000.

At operation 514, the LLM module 110 submits the generated and validated prompt to the LLM. Submission of the prompt may additionally comprise submission and/or confirmation of the configured LLM parameters. In an example, submitting the prompt “Generate a story about the game where this baseball bat was used by Babe Ruth in a game against the Chicago White Sox.” to the LLM.

At operation 516, the LLM module 110 receives a response from the LLM. In some examples, the LLM may respond with generative text. In other examples, the LLM may respond with tables, diagrams, figures, images, or a combination thereof. In some examples, the LLM may respond with audio and/or video. In an example, the LLM response comprises a story about Babe Ruth hitting a 3-run homerun in the 8th inning of an away game in Chicago against the White Sox. Additionally, the LLM module 110 incorporates a feature for content filtering based on the user's preferences and requirements, addressing concerns about anonymous content creation and the nature of the content shared. This feature enables users to set filters for viewing SIO data, such as excluding anonymous submissions, hate speech, swearing, or pornographic content. Users have the flexibility to customize their content experience, for instance, choosing to view only anonymous posts or specific types of content, akin to a ‘tagged graffiti wall’ in a digital space. This customization is crucial for ensuring a safe and relevant user experience, especially when dealing with a wide range of user-generated content. The LLMs play a key role in categorizing and filtering content based on these user-defined parameters, ensuring that the content displayed aligns with the user's chosen filters. For example, the LLM can be configured to recognize and filter out content that falls under hate speech, while still allowing other forms of anonymous postings. This balance of open expression and user safety is critical in the SIO system, especially when dealing with the diverse and often unpredictable nature of user-generated content.

At operation 518, the LLM module 110 sends the received LLM response to the server system 104.

FIG. 6 is a flow diagram illustrating a process performed by iterative refinement module 112, according to some examples.

At operation 602, the iterative refinement module 112 receives an LLM response and the one or more selected SIO objects. In an example, the LLM response comprises a story about Babe Ruth hitting a 3-run homerun in the 8th inning of an away game in Chicago against the White Sox and the selected SIO objects comprise at bats by Babe Ruth in games played against the Chicago White Sox.

At operation 604, the iterative refinement module 112 queries an SIO database 118 for data related to the LLM response. The SIO database 118 may additionally be queried for data related to the one or more selected SIO objects. In an example, querying for data related to the Chicago White Sox, such as pitchers who pitched against Babe Ruth during home games.

At operation 606, the iterative refinement module 112 displays the LLM response and SIO data to the user via a user device 128. The SIO data may comprise at least the selected SIO objects and may further comprise SIO data related to the selected SIO objects and/or the LLM response. In an example, displaying an LLM response comprising a story about Babe Ruth hitting a 3-run homerun in the 8th inning of an away game in Chicago against the White Sox, and SIO data relating to pitchers for the Chicago White Sox who pitched against Babe Ruth, specifically those whom Babe Ruth hit one or more home runs against.

At operation 608, the iterative refinement module 112 receives a user input in response to the displayed LLM response and SIO data. The user input may comprise manual adjustments to the response such as adding additional detail, correcting inaccuracies, or a combination thereof. In some examples, the user input may comprise creating and/or updating associations between one or more SIO objects. In some examples, the user input may comprise a request to regenerate part or all of the LLM response. In some examples, the user input may comprise natural language feedback to be resubmitted to an LLM to generate an updated LLM response. In an example, the user input comprises a request to modify the story to be from the perspective of his grandfather, sitting in the stands, watching the homerun being hit by Babe Ruth. The user may additionally modify details of the story such that the homerun was a grand slam instead of a three-run homerun.

At operation 610, the iterative refinement module 112 modifies the LLM response based upon the received user input. In an example, the modification of the LLM response may be updating the LLM response with edits made by the user. In other examples, the user data and/or feedback may be resubmitted to an LLM to generate an updated LLM response. In some examples, the user may indicate that the LLM response should be regenerated with or without modifications to the prompt. In examples where the prompt is to be updated, modifying the LLM response may comprise modifying the original LLM prompt used to generate the LLM response, or alternatively providing data and/or instructions to be used to modify the LLM response used to generate the LLM response. In an example, the modified LLM response includes a request to generate additional content describing the event from the perspective of his grandfather sitting in the stands watching Babe Ruth hit a homerun. The LLM response is further modified by changing the detail of ‘three-run homerun’ to be a grand slam.

At operation 612, the iterative refinement module 112 sends the modified LLM response to the server system 104. In some examples, the modified LLM response may comprise a request to regenerate the LLM response. In such examples, the LLM response may comprise an updated LLM prompt, or data and/or instructions to be used to modify the LLM prompt to generate a new LLM response. Further expanding on the iterative refinement module 112, the object generation and trust assessment system 100 may integrate a content compliance feature that assists users in aligning their contributions with the platform's content filters. This feature automatically analyzes the user-generated content against the set content filters such as anonymity, hate speech, profanity, and explicit material. If potential violations are detected, the system provides real-time feedback to the user, highlighting areas of concern and suggesting modifications to ensure compliance with the desired content standards. This proactive approach not only informs users of the specific content filters their submissions may violate but also encourages them to refine their content to create a safe and relevant environment for a broader user base. In some examples, a user interface element may present users with an overview of the content filters applied to their submission, offering insights into how their content is perceived within the platform's guidelines. Users can interact with this feature to understand the impact of their choices on content visibility and audience reach. This approach empowers users to make informed decisions about their content, balancing personal expression with community standards. Additionally, the object generation and trust assessment system 100 incorporates a user feedback loop, where users can provide input on the content compliance suggestions. This feedback is crucial for the continuous improvement of the content analysis algorithms, ensuring that the system remains sensitive to the evolving dynamics of user interaction and community norms. Through this iterative process, users are not only participants in content creation but also active contributors to the platform's growth and refinement, fostering a collaborative and respectful digital ecosystem.

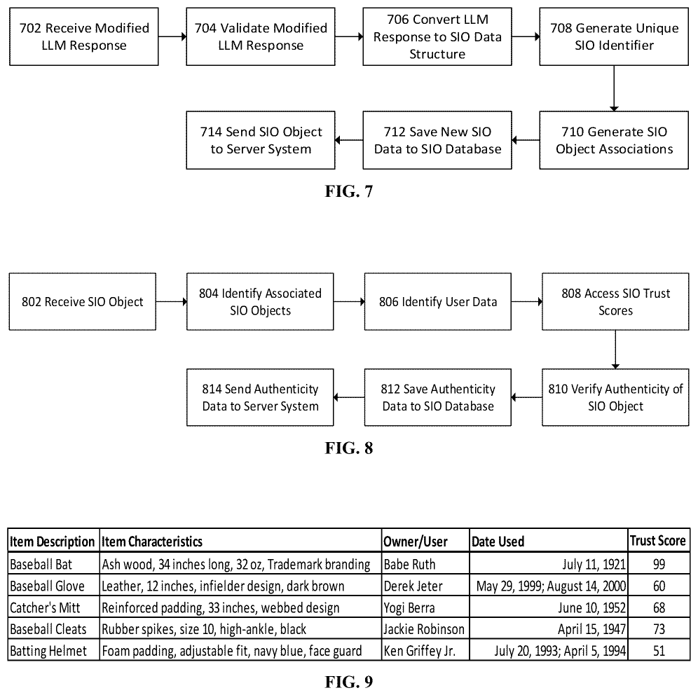

FIG. 7 is a flow diagram illustrating a process performed by conversion module 114, according to some examples.

At operation 702, the conversion module 114 receives a modified LLM response. The modified LLM response comprising a response generated at least in part by an LLM and may additionally comprise modifications from a user. In some examples, the modified LLM response may additionally comprise associations between SIO objects, which may include associations between the LLM response and one or more SIO objects.

At operation 704, the conversion module 114 validates the modified LLM response. Validation of the LLM response may comprise verifying that the LLM response comprises all required data elements necessary for the conversion of the LLM response to an SIO object. In some examples, a user may be prompted to provide missing details if the LLM response cannot be fully validated. In other examples, an LLM may be utilized to generate missing data elements to enable the LLM response to be converted to an SIO object. In other examples, validation of the modified LLM response may comprise replacing and/or populating invalid data elements of an LLM response with default values to enable the LLM response to be converted to an SIO data structure. In an example, the LLM response is invalid because it lacks a team for which Babe Ruth was playing which is required for the current SIO data structure, and therefore automatically generates the data for the team as New York Yankees. The user may further be prompted to verify the generated data, the user then correcting the data to be Boston Red Sox.

At operation 706, the conversion module 114 converts the modified LLM response to an SIO data structure. An SIO data structure may vary depending on its implementation. For example, in some examples, an SIO data structure may comprise an SQL database with required fields varying between SQL implementations. Likewise, an SIO data structure may comprise a NoSQL database. In other examples, an SIO data structure may be a proprietary format. In other examples, an SIO data structure may comprise, at least in part, a vector database or hash table. Likewise, in some examples, an LLM response converted to an SIO data structure may be indexed to facilitate efficient discovery during queries. In an example, generating an SIO object comprising an at bat by Babe Ruth while playing for the Boston Red Sox against the Chicago White Sox in Chicago.

At operation 708, the conversion module 114 generates a unique SIO identifier or ID. An SIO ID may be an alphanumeric string of characters and may optionally comprise symbols. The SIO ID may further be associated with permissions, such as user accounts with access to view and/or edit the SIO.

At operation 710, the conversion module 114 generates one or more SIO object associations. In some examples, the SIO object associations may have been provided by the user when modifying the LLM response. In other examples, the object associations may have been indicated by the user when the user selected SIO objects to be used in the prompt(s) which generated the LLM response. Likewise, associations between the LLM response converted into an SIO object data structure may be inherited based upon the associations existing between the SIO objects selected by the user. In some examples, the SIO object associations may be identified via analysis of the LLM response. For example, natural language processing and/or an LLM may be used to identify SIO object references within the LLM response, and further, the context in which the SIO objects are referenced may be used to identify SIO object associations within the LLM response without the need for user interaction. In some examples, a user may verify and SIO object associations which are automatically identified. In an example, generating an association between the new SIO object and Babe Ruth, the baseball bat in possession of the user, and the user's grandfather.

At operation 712, the conversion module 114 saves the SIO data (i.e., new SIO data) to an SIO database 118. The SIO data comprises at least an SIO object generated from a conversion of the modified LLM response into an SIO data structure. The SIO data may additionally comprise one or more SIO object associations. The SIO data may further comprise permissions data, which may indicate which user accounts have access to view and/or edit the SIO object. In some examples, the new SIO object may be assigned to the currently authorized user account by default. In other examples, the user may indicate the user account to whom the SIO object should be assigned. In further examples, the read and/or edit permissions may be determined by the first system 102 based upon whether other users are identified as having been referenced by the LLM response and/or the new SIO object.

At operation 714, the conversion module 114 sends the generated SIO object to the server system 104.

FIG. 8 is a flow diagram illustrating a process performed by assessment module 116, according to some examples.

At operation 802, the assessment module 116 receives an SIO object. In an example, the SIO object comprises an at bat by Babe Ruth while playing for the Boston Red Sox against the Chicago White Sox in Chicago.

At operation 804, the assessment module 116 identifies SIO objects associated with the received SIO object. In an example, associated SIO objects may comprise players for the Chicago White Sox who played against Babe Ruth, players for the Boston Red Sox who played with Babe Ruth, bats used by Babe Ruth, games between the Chicago White Sox and the Boston Red Sox in which Babe Ruth played, or a combination thereof.

At operation 806, the assessment module 116 identifies user data associated with the SIO object. The user data may further be identified for SIO objects associated with the received SIO object. In an example, user data comprises user IDs and trust scores for users who contributed to the associated SIO objects.

At operation 808 the assessment module 116 accesses SIO trust scores with one or more SIO objects and/or the users associated with the SIO objects. A trust score may represent the accuracy of the SIO object as indicated by one or more of associated SIO objects, users associated with the one or more associated SIO objects, and/or verified experts, who have been confirmed to have relevant expertise relating to the SIO object(s). In some examples, the trust scores may represent the degree of correlation between SIO objects and/or user accounts. For example, a higher SIO trust score indicates that more SIO objects have similar or identical details than would be indicated by a lower SIO trust score, which may indicate less agreement and/or greater variation of data elements between the received SIO object and associated SIO objects. In some examples, the SIO trust score may be dependent at least in part on a trust score assigned to the one or more users associated with the SIO object indicating the reliability of the user based upon the user's past SIO data contributions.

At operation 810, the assessment module 116 verifies the authenticity of the SIO object based upon the identified SIO objects, identified user data, and associated SIO trust scores. In some examples, the authenticity may be verified if an aggregate SIO trust score of the associated SIO objects and/or associated users, exceeds a threshold value, such as 70%. In some examples, the authenticity may comprise a trust score. In other examples, the trust score, explicitly determined, or an aggregate of associated object and user SIO trust scores, may utilize weighting based upon the degree to which the associated object and/or user influences the accuracy of the received SIO object. For example, associated SIO objects may be divided between primary and secondary associations, such that primary associations have a significant relationship to the authenticity of the SIO object, and where secondary associations have a lesser relationship to the authenticity of the SIO object. In an example, the SIO authenticity data comprises a trust score of 78. In another example, the authentication data comprising a binary assessment of authentic. The authentication data may additionally comprise a qualitative indication that the authentication method utilized was an automated comparison of SIO object data and an aggregation of trust scores.

At operation 812, the assessment module 116 saves the SIO object authenticity data to the SIO database 118. The SIO object authenticity data may comprise a binary assessment of whether the SIO object is authentic. In other examples, the SIO object authentication data may comprise a quantitative value indicating the level of authenticity of the SIO object. In further examples, a qualitative indication may be provided indicating the method by which the authenticity of the SIO object has been verified. For example, an SIO object's authenticity may be verified via an automated method, such as an algorithm, aggregate trust score, or a combination thereof, or may alternatively be independently verified by one or more experts.

At operation 814, the assessment module 116 sends the SIO object authenticity data to the server system 104.

FIG. 9 is a table illustrating exemplary details about different exemplary categories of SIO data in the SIO database 118, according to some examples.

In some examples, the SIO database 118 may store SIO data comprising of SIO objects, SIO object associations, users associated with the SIO objects and user roles and permissions defining which SIO objects each user can view and similarly which SIO objects the user can edit.

The SIO database 118 may be populated and used by the authentication module 106, SIO enabled prompt module 108, LLM module 110, iterative refinement module 112, conversion module 114, and the assessment module 116. The SIO database 118 may further be updated by a first system 102, third party network 122, third party database 124, IoT data source 126, or data collected via a user device 128, camera 130, or one or more sensors 132.

In some examples, the SIO database 118 incorporates advanced content filtering mechanisms, essential for managing the diverse and dynamic nature of user-generated content within the SIO system. This functionality addresses the challenges associated with anonymous content creation and the diverse preferences of end users regarding content visibility and appropriateness. The content filters within the SIO database are designed to categorize and flag content based on various criteria, including but not limited to anonymity, hate speech, profanity, and explicit material. These filters operate to assist in maintaining the integrity and safety of the platform by preventing the display of content that violates predefined community standards. In some examples, the content filters allow users to personalize their content experience. Users can selectively enable or disable viewing of certain types of content based on their preferences. For example, a user might choose to filter out all anonymous content or specifically view only content that is tagged as anonymous. Similarly, users have the option to exclude or include content flagged for hate speech, swearing, or adult themes, depending on their comfort and interest levels.

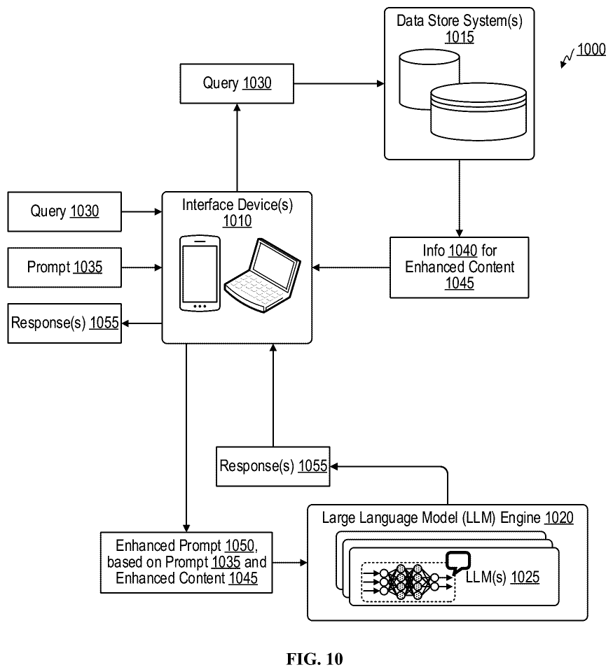

FIG. 10 is a block diagram illustrating a retrieval augmented generation (RAG) system 1000 that may be used to implement some aspects of the technology. The RAG system 1000 includes one or more interface device(s) 1010 that can receive input(s) from a user and/or a user device 128, for instance by receiving a query 1030 and/or a prompt 1035 from the user and/or the system.

The interface device(s) 1010 can send the query 1030 to one or more data store system(s) 1015 that include, and/or that have access to (e.g., over a network connection), various data store(s) (e.g., database(s), table(s), spreadsheet(s), tree(s), ledger(s), heap(s), and/or other data structure(s)). The data store system(s) 1015 searches the data store(s) according to the query 1030. In some examples, the interface device(s) 1010 and/or the system(s) 1015 convert the query 1030 into tensor format (e.g., vector format and/or matrix format). In some examples, the data store system(s) 1015 searches the data store(s) (e.g., the SIO database 118) according to the query 1030 by matching the query 1030 with data in tensor format (e.g., vector format and/or matrix format) stored in the data store(s) that are accessible to the data store system(s) 1015. The data store system(s) 1015 retrieve, from the data store(s) and based on the query 1030, information 1040 that is relevant to generating enhanced content 1045.

In some examples, the data store system(s) 1015 provide the information 1040 and/or the enhanced content 1045 to the interface device(s) 1010. In some examples, the data store system(s) 1015 provide the information 1040 to the interface device(s) 1010, and the interface device(s) 1010 generate the enhanced content 1045 based on the information 1040. The interface device(s) 1010 provides the query 1030, the prompt 1035, the information 1040, the enhanced content 1045, and/or enhanced prompt 1050 based on prompt 1035 and enhanced content 1045 to one or more ML model(s) 1025 (e.g., ML model(s) 1125) of an ML engine 1020 (e.g., ML engine 1120). The ML model(s) 1025 generate response(s) 1055 that are responsive to the prompt 1035. In some examples, the response(s) 1055 may be, or may include, details and/or additional details of an object that the query is based on.

In some examples, the ML model(s) 1025 generate the response(s) 1055 (e.g., including the details of an object) based on the query 1030, the prompt 1035, the information 1040, the enhanced content 1045, and/or the enhanced prompt 1050. In some examples, the ML model(s) 1025 generate the response(s) 1055 to include, or be based on, the information 1040 and/or the enhanced content 1045. The ML model(s) 1025 provides the response(s) 1055 to the interface device(s) 1010. In some examples, the interface device(s) 1010 output the response(s) 1055 to the user (e.g., to the user device of the user) that provided the query 1030 and/or the prompt 1035. In some examples, the interface device(s) 1010 output the response(s) 1055 to the system (e.g., the other ML model) that provided the query 1030 and/or the prompt 1035 to the interface device(s) 1010. In some examples, the data store system(s) 1015 may include one or more ML model(s) that are trained to perform the search of the data store(s) based on the query 1030.

In some examples, the system(s) 1015 provides the information 1040 and/or the enhanced content 1045 directly to the ML model(s) 1025, and the interface device(s) 1010 provide the query 1030 and/or the prompt 1035 to the ML model(s) 1025. The ML engine 1020 may be an example of the ML engine 1120, or vice versa. The ML model(s) 1025 may be example(s) of the ML model(s) 1125, or vice versa.

In an illustrative example, the interface device(s) 1010 may receive the query 1030 to request the response(s) to include specific SIO elements comprising specific components of an object (e.g., a description of a baseball bat used by a specific baseball player, such as Babe Ruth). The corresponding prompt 1035 can include further information (e.g., request the response to be in a specific format and/or request response to be in specific types of components such as historical, descriptive, and/or emotional elements). The data store system(s) 1015 can interpret the query 1030 and search, based on the query 1030, the various data store(s) that the data store system(s) 1015 have access to, to output information 1040 identifying additional types of specific components about the object, emotions associated with the object, history associated with the object, descriptions involving the object, any other types of components of the object discussed herein, or a combination thereof.

The data store system(s) 1015 can output this information 1040 to the interface device(s) 1010, which can generate enhanced content 1045 and/or enhanced prompt 1050. In some examples, the enhanced content 1045 adds or appends the information 1040 to the prompt 1035 and/or the query 1030. In some examples, the data store system(s) 1015 and/or the interface device(s) 1010 generate the enhanced content 1045 and/or enhanced prompt 1050 by modifying the query 1030 and/or the prompt 1035 before providing the query 1030 and/or the prompt 1035 to the ML model(s) 1025. For instance, the data store system(s) 1015 and/or the interface device(s) 1010 can generate the enhanced content 1045 by modifying the query 1030 and/or the prompt 1035 to instruct the ML model(s) 1025 to generate the response(s) 1055 with specific SIO element(s). In this way, the ML model(s) 1025 do not need to seek out specific components of the object, because the query 1030 and/or the prompt 1035 are already modified to include this information. In this way, the ML model(s) 1025 are more optimally configured to generate response(s) 1055 that are accurate and factor in up-to-date SIO clement(s) from the data store(s) that the data store system(s) 1015 have access to.

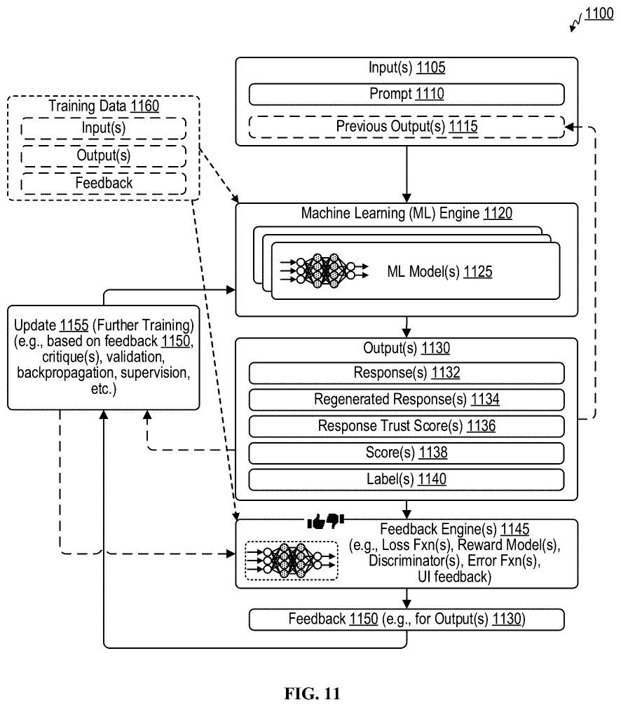

FIG. 11 is a block diagram illustrating an example of a machine learning system 1100 for training and use of one or more machine learning model(s) 1125 used to generate response(s) 1132, regenerated response(s) 1134, response trust score(s) 1136, score(s) 1138, and/or label(s) 1140. The response trust score(s) 1136 can be associated with response(s) 1132, and/or with regenerated response(s) 1134. The machine learning (ML) system 1100 includes an ML engine 1120 that generates, trains, uses, and/or updates one or more ML model(s) 1125. In some examples, the object generation and trust assessment system 100 include the ML system 1100, the ML engine 1120, the ML model(s) 1125, and/or the feedback engine(s) 1145, or vice versa.

The ML model(s) 1125 can include, for instance, one or more neural network(s) (NN(s)), one or more convolutional NN(s) (CNN(s)), one or more time delay NN(s) (TDNN(s)), one or more deep network(s) (DN(s)), one or more autoencoder(s) (AE(s)), one or more variational autoencoder(s) (VAE(s)), one or more deep belief net(s) (DBN(s)), one or more recurrent NN(s) (RNN(s)), one or more generative adversarial network(s) (GAN(s)), one or more conditional GAN(s) (cGAN(s)), one or more feed-forward network(s), one or more network(s) having fully connected layers, one or more support vector machine(s) (SVM(s)), one or more random forest(s) (RF), one or more computer vision (CV) system(s), one or more autoregressive (AR) model(s), one or more Sequence-to-Sequence (Seq2Seq) model(s), one or more large language model(s) (LLM(s)), one or more deep learning system(s), one or more classifier(s), one or more transformer(s), or a combination thereof. In examples where the ML model(s) 1125 include LLMs, the LLMs can include, for instance, a Generative Pre-Trained Transformer (GPT) (e.g., GPT-2, GPT-3, GPT-3.5, GPT-4, etc.), DaVinci or a variant thereof, an LLM using Massachusetts Institute of Technology (MIT)® langchain, Pathways Language Model (PaLM), Large Language Model Meta® AI (LLaMA), Language Model for Dialogue Applications (LaMDA), Bidirectional Encoder Representations from Transformers (BERT), Falcon (e.g., 40B, 7B, 1B), Orca, Phi-1, StableLM, variant(s) of any of the previously-listed LLMs, or a combination thereof.

Within FIG. 11, a graphic representing the ML model(s) 1125 illustrates a set of circles connected to one another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. An ML model can include more or fewer hidden layers than the two illustrated, but includes at least one hidden layer. In some examples, the layers and/or nodes represent interconnected filters, and information associated with the filters is shared among the different layers with each layer retaining information as the information is processed. The lines between nodes can represent node-to-node interconnections along which information is shared. The lines between nodes can also represent weights (e.g., numeric weights) between nodes, which can be tuned, updated, added, and/or removed as the ML model(s) 1125 are trained and/or updated. In some cases, certain nodes (e.g., nodes of a hidden layer) can transform the information of each input node by applying activation functions (e.g., filters) to this information, for instance applying convolutional functions, downscaling, upscaling, data transformation, and/or any other suitable functions.

In some examples, the layers and/or nodes represent interconnected filters, and information associated with the filters is shared among the different layers with each layer retaining information as the information is processed. The lines between nodes can represent node-to-node interconnections along which information is shared. The lines between nodes can also represent weights (e.g., numeric weights) between nodes, which can be tuned, updated, added, and/or removed as the ML model(s) 1125 are trained and/or updated. In some cases, certain nodes (e.g., nodes of a hidden layer) can transform the information of each input node by applying activation functions (e.g., filters) to this information, for instance applying convolutional functions, downscaling, upscaling, data transformation, and/or any other suitable functions.

In some examples, the ML model(s) 1125 can include a feed-forward network, in which case there are no feedback connections where outputs of the network are fed back into itself. In some cases, the ML model(s) 1125 can include a recurrent neural network, which can have loops that allow information to be carried across nodes while reading in input. In some cases, the network can include a convolutional neural network, which may not link every node in one layer to every other node in the next layer.

One or more input(s) 1105 can be provided to the ML model(s) 1125. The ML model(s) 1125 can be trained by the ML engine 1120 (e.g., based on training data 1160) to generate one or more output(s) 1130. In some examples, the input(s) 1105 may include a prompt 1110. The prompt 1110 can include, for instance, a query, an enhanced prompt, or a combination thereof.

The output(s) 1130 that ML model(s) 1125 generate by processing the input(s) 1105 (e.g., the prompt 1110 and/or the previous output(s) 1115) can include response(s) 1132, regenerated response(s) 1134, response trust score(s) 1136, score(s) 1138, and/or label(s) 1140. The response(s) 1132 is, for instance, a transcript that is responsive to the prompt 1110. For example, the response(s) 1132 can be a generative text, tables, diagrams, figures, images, or a combination thereof. In some examples, the response(s) 1132 is a series of sentences that answer the query that the prompt is seeking to ask. For example, the response(s) 1132 comprises a story about Babe Ruth hitting a 3-run homerun in the 8th inning of an away game in Chicago against the White Sox. In some examples, the LLM may respond with audio and/or video.

Regenerated response(s) 1134 can include, for instance, a modified LLM response based upon a received user input. In an example, the modification of the LLM response may be updating the LLM response with edits made by the user. In other examples, the user data and/or feedback may be resubmitted to an LLM to generate an updated LLM response. In some examples, the user may indicate that the LLM response should be regenerated with or without modifications to the prompt. In examples where the prompt is to be updated, modifying the LLM response may comprise modifying the original LLM prompt used to generate the LLM response, or alternatively providing data and/or instructions to be used to modify the LLM response used to generate the LLM response. The modified LLM response includes a request to generate additional content describing the event. For example, where a response(s) 1132 is about an event where Babe Ruth hitting a home run, the additional content of the regenerated response(s) 1134 can be the perspective of user's grandfather sitting in the stands watching Babe Ruth hit a homerun.

Response trust score(s) 1136 can refer to a determined or predicted level of trust, confidence, reputation, accuracy, verification, validation, or a combination thereof, associated with the response(s) 1132 and/or the regenerated response(s) 1134. For instance, the response trust score(s) 1136 can be based on the prompt 1110, the previous output(s) 1115, and/or other type(s) of input(s) 1105. For instance, in some examples, the input(s) 1105 can include scores (e.g., relating to trust, confidence, reputation, accuracy, verification, validation, or a combination thereof) associated with data elements (e.g., SIO data elements) and/or users associated with the data elements (e.g., authors of the data elements, creators of the data elements, owners of the data elements, users of devices that generated the data elements, users of devices storing the data elements, users of devices associated with the data elements, or combinations thereof). For instance, in some examples, a trust score or reputation score of a user can be based on the level of education of the user (e.g., high school, undergraduate, graduate, doctorate, and the like), based on whether a type of the data element aligns with a background of the user (e.g., the user is a doctor and the data element is medicine-related, the user is a lawyer and the data element is law-related, the user is an expert in a subject and the data is related to that subject), based on reports (e.g., by other user(s)) of accuracy or inaccuracy of data element(s) related to the user, based on reviews or ratings of the user and/or related data element(s) (e.g., by other user(s)), or a combination thereof. Trust scores associated with data elements can be based on the trust scores or reputation scores of their associated users (e.g., creators, authors, owners, or any of the other types of associated users listed above), based on reports (e.g., by other user(s)) of accuracy or inaccuracy of the data elements, based on reviews or ratings of the data elements (e.g., by other user(s)), or a combination thereof. The input(s) 1105 that are used by the ML model(s) 1125 to generate the response trust score(s) 1136 can include any of the types of scores discussed herein as related to users and/or data element(s). In some examples, the ML model(s) 1125 can generate the response trust score(s) 1136 based on trust scores (and/or other scores) for the data element(s) that the ML model(s) 1125 relied upon to generate the response(s) 1132 and/or the regenerated response(s) 1134, based on trust scores or reputation scores (and/or other scores) associated with users who are associated with those data element(s), or a combination thereof. In some examples, the response trust score(s) 1136 can be referred to as trust scores, confidence scores, reputation scores, accuracy scores, verification scores, validation scores, truth scores, or a combination thereof. In some examples, the ML model(s) 1125 can be used to generate any of the types of scores discussed herein for the data elements (e.g., SIO data elements) and/or users associated with the data elements (e.g., authors of the data elements, creators of the data elements, owners of the data elements, users of devices that generated the data elements, users of devices storing the data elements, users of devices associated with the data elements, or combinations thereof), instead of or in addition to generating the response trust score(s) 1136.

Score(s) 1138 can refer to a determined level of deviation, imbalance, divergence, disproportion, or a combination thereof, based on representation information, coverage information, and/or sentiment information associated with the response(s) 1132, the regenerated response(s) 1134, and/or the response trust score(s) 1136. In some examples, the score(s) 1138 can be generated based on the prompt 1110, the previous output(s) 1115, and/or other type(s) of input(s) 1105. In some examples, the type(s) of input(s) 1105 can include one or more attributes corresponding to the representation information, coverage information, and/or sentiment information associated with the response(s) 1132, the regenerated response(s) 1134, and/or the response trust score(s) 1136. For instance, the one or more attributes can include a political attribute. In some examples, scores(s) 1138 can be generated and assigned to the response(s) 1132 and the regenerated response(s) 1134 that are associated with representation information, coverage information, and/or sentiment information. In some examples, score(s) 1138 can be quantified in numerical values that represent how much the information deviates from a predetermined baseline expectation. For example, score(s) 1138 can be quantified based on percentages differences between representations. For example, the response(s) 1132 and/or the regenerated response(s) 1134 can include news summaries that show 90% positive sentiment toward Party A and 10% toward Party B. In such a case, the imbalance of coverage can be measured by the difference between the percentages of positive sentiments toward each party, which is 80%. Thus, a score 1138 can be assigned to the response(s) 1132 and/or the regenerated response(s) 1134 to reflect the 80% deviation and/or imbalance. In some examples, the predetermined baseline expectation can be neutrality in coverage where an attribute of interest is political (e.g., equal positive coverage for both political parties is expected).

Label(s) 1140 can refer to a classification of the response(s) 1132 and/or the regenerated response(s) 1134 based on a predefined threshold. In some examples, the response(s) 1132 and/or the regenerated response(s) 1134 can be assigned as “biased” or “neutral,” based on a predefined threshold. For example, in a case where the predetermined threshold is set at 20% imbalance, the response(s) 1132 and/or the regenerated response(s) 1134 covering news summaries that show 90% positive sentiment toward Party A and 10% toward Party B, thereby creating 80% imbalance in coverage, can be labeled as “biased,” since 80% exceeded 20% predetermined threshold. Alternatively, in the same example, the response(s) 1132 and/or the regenerated response(s) 1134 can be assigned as “pro-Party A.”

The ML model(s) 1125 can generate the response(s) 1132 based on the prompt 1110 and/or other types of input(s) 1105 (e.g., previous output(s) 1115). In some examples, the response(s) 1132 can be used as part of the input(s) 1105 to the ML model(s) 1125 (e.g., as part of previous output(s) 1115) for generating regenerated response(s) 1134, for generating response trust score(s) 1136, for generating score(s) 1138, for generating label(s) 1140, and/or for generating other output(s) 1130. In some examples, the response trust score(s) 1136 can be an aggregated SIO trust score of the associated SIO objects of the regenerated response(s) 1134 and/or associated users. In some examples, at least some of the previous output(s) 1115 in the input(s) 1105 represent previously-identified score(s) that are input into the ML model(s) 1125 to generate regenerated response(s) 1134, generate response trust score(s) 1136, generate score(s) 1138, generate label(s) 1140, and/or other output(s) 1130. In some examples, based on receipt of the input(s) 1105, the ML model(s) 1125 can select the output(s) 1130 from a list of possible outputs, for instance by ranking the list of possible outputs by likelihood, probability, and/or confidence based on the input(s) 1105. In some examples, based on receipt of the input(s) 1105, the ML model(s) 1125 can identify the output(s) 1130 at least in part using generative artificial intelligence (AI) content generation techniques, for instance using an LLM to generate custom text and/or graphics identifying the output(s) 1130.

In some examples, the ML system 1100 repeats the process illustrated in FIG. 11 multiple times to generate the output(s) 1130 in multiple passes, using some of the output(s) 1130 from earlier passes as some of the input(s) 1105 in later passes (e.g., as some of the previous output(s) 1115). For instance, in a first illustrative example, in a first pass, the ML model(s) 1125 can generate the response(s) 1132 based on input of the prompt 1110 into the ML model(s) 1125. In a second pass, the ML model(s) 1125 can generate regenerated response(s) 1134 based on input of the prompt 1110 and the previous output(s) 1115 (that includes the response(s) 1132 from the first pass) into the ML model(s) 1125. In a third pass, the ML model(s) 1125 can generate response trust score(s) 1136 based on input of the prompt 1110 and the previous output(s) 1115 (that includes the response(s) 1132 from the first pass and/or the regenerated response(s) 1134 from the second pass) into the ML model(s) 1125. In a fourth pass, the ML model(s) 1125 can generate score(s) 1138 based on input of the prompt 1110 and the previous output(s) 1115 (that includes the response(s) 1132 from the first pass, the regenerated response(s) 1134 from the second pass, and/or the response trust score(s) 1136 from the third pass) into the ML model(s) 1125. In a fifth pass, the ML model(s) 1125 can generate label(s) 1140 based on input of the prompt 1110 and the previous output(s) 1115 (that includes the response(s) 1132 from the first pass, the regenerated response(s) 1134 from the second pass, the response trust score(s) 1136 from the third pass, and/or the score(s) 1138 from the fourth pass) into the ML model(s) 1125. In some examples, response trust score(s) can be generated by analyzing the input(s) 1105. For example, the inputs may include trust scores of one or more of associated SIO objects, user trust score assigned to one or more users associated with SIO objects (i.e., user authentication data), which indicates the reliability of the user based on the user's past SIO data contributions (i.e., user input), and/or information associated with verified experts who have been confirmed to have relevant expertise relating to the SIO object(s).

In some examples, the ML system includes one or more feedback engine(s) 1145 that generate and/or provide feedback 1150 about the output(s) 1130. In some examples, the feedback 1150 indicates how well the output(s) 1130 align to corresponding expected output(s), how well the output(s) 1130 serve their intended purpose, or a combination thereof. In some examples, the feedback engine(s) 1145 include loss function(s), reward model(s) (e.g., other ML model(s) that are used to score the output(s) 1130), discriminator(s), error function(s) (e.g., in back-propagation), user interface feedback received via a user interface from a user, or a combination thereof. In some examples, the feedback 1150 can include one or more alignment score(s) that score a level of alignment between the output(s) 1130 and the expected output(s) and/or intended purpose.

The ML engine 1120 of the ML system can update (further train) the ML model(s) 1125 based on the feedback 1150 to perform an update 1155 (e.g., further training) of the ML model(s) 1125 based on the feedback 1150. In some examples, the feedback 1150 includes positive feedback, for instance indicating that the output(s) 1130 closely align with expected output(s) and/or that the output(s) 1130 serve their intended purpose. In some examples, the feedback 1150 includes negative feedback, for instance indicating a mismatch between the output(s) 1130 and the expected output(s), and/or that the output(s) 1130 do not serve their intended purpose. For instance, high amounts of loss and/or error (e.g., exceeding a threshold) can be interpreted as negative feedback, while low amounts of loss and/or error (e.g., less than a threshold) can be interpreted as positive feedback. Similarly, high amounts of alignment (e.g., exceeding a threshold) can be interpreted as positive feedback, while low amounts of alignment (e.g., less than a threshold) can be interpreted as negative feedback.

In response to positive feedback in the feedback 1150, the ML engine 1120 can perform the update 1155 to update the ML model(s) 1125 to strengthen and/or reinforce weights (and/or connections and/or hyperparameters) associated with generation of the output(s) 1130 to encourage the ML engine 1120 to generate similar output(s) 1130 given similar input(s) 1105. In this way, the update 1155 can improve the ML model(s) 1125 itself by improving the accuracy of the ML model(s) 1125 in generating output(s) 1130 that are similarly accurate given similar input(s) 1105. In response to negative feedback in the feedback 1150, the ML engine 1120 can perform the update 1155 to update the ML model(s) 1125 to weaken and/or remove weights (and/or connections and/or hyperparameters) associated with generation of the output(s) 1130 to discourage the ML engine 1120 from generating similar output(s) 1130 given similar input(s) 1105. In this way, the update 1155 can improve the ML model(s) 1125 itself by improving the accuracy of the ML model(s) 1125 in generating output(s) 1130 are more accurate given similar input(s) 1105. In some examples, for instance, the update 1155 can improve the accuracy of the ML model(s) 1125 in generating output(s) 1130 by reducing false positive(s) and/or false negative(s) in the output(s) 1130.

For instance, here, if the response(s) 1132 are successfully used to generate regenerated response(s) 1134 and/or the generating of the response trust score(s) 1136 is successful, this success can be interpreted as feedback 1150 that is positive (e.g., positive feedback). On the other hand, if the response(s) 1132 are not usable to generate regenerated response(s) 1134, and/or the generating of the response trust score(s) 1136 fails or is unsuccessful, this failure or lack of success can be interpreted as feedback 1150 that is negative (e.g., negative feedback). Either way, the update 1155 can improve the machine learning system 1100 and the overall system by improving the consistency with which the outputting an arrangement of at least a subset of the plurality of data elements is successful.

In some examples, the ML engine 1120 can also perform an initial training of the ML model(s) 1125 before the ML model(s) 1125 are used to generate the output(s) 1130 based on the input(s) 1105. During the initial training, the ML engine 1120 can train the ML model(s) 1125 based on training data 1160. In some examples, the training data 1160 includes examples of input(s) (of any input types discussed with respect to the input(s) 1105), output(s) (of any output types discussed with respect to the output(s) 1130), and/or feedback (of any feedback types discussed with respect to the feedback 1150). In some cases, positive feedback in the training data 1160 can be used to perform positive training, to encourage the ML model(s) 1125 to generate output(s) similar to the output(s) in the training data given input of the corresponding input(s) in the training data. In some cases, negative feedback in the training data 1160 can be used to perform negative training, to discourage the ML model(s) 1125 from generate output(s) similar to the output(s) in the training data given input of the corresponding input(s) in the training data. In some examples, the training of the ML model(s) 1125 (e.g., the initial training with the training data 1160, update(s) 1155 based on the feedback 1150, and/or other modification(s)) can include fine-tuning of the ML model(s) 1125, retraining of the ML model(s) 1125, or a combination thereof.

In some examples, the ML model(s) 1125 can include an ensemble of multiple ML models, and the ML engine 1120 can curate and manage the ML model(s) 1125 in the ensemble. The ensemble can include ML model(s) 1125 that are different from one another to produce different respective outputs, which the ML engine 1120 can average (e.g., mean, median, and/or mode) to identify the output(s) 1130. In some examples, the ML engine 1120 can calculate the standard deviation of the respective outputs of the different ML model(s) 1125 in the ensemble to identify a level of confidence in the output(s) 1130. In some examples, the standard deviation can have an inverse relationship with confidence. For instance, if the respective outputs of the different ML model(s) 1125 are very different from one another (and thus have a high standard deviation above a threshold), the confidence that the output(s) 1130 are accurate may be low (e.g., below a threshold). On the other hand, if the respective outputs of the different ML model(s) 1125 are equal or very similar to one another (and thus have a low standard deviation below a threshold), the confidence that the output(s) 1130 are accurate may be high (e.g., above a threshold). In some examples, different ML models(s) 1125 in the ensemble can include different types of models. In some examples, the ensemble may include different ML model(s) 1125 that are trained to process different inputs of the input(s) 1105 and/or to generate different outputs of the output(s) 1130. For instance, in some examples, a first model (or set of models) can process the input(s) 1105 to generate the response(s) 1132, while a second model (or set of models) can process the input(s) 1105 to generate regenerated response(s) 1134. In some examples, the ML engine 1120 can choose specific ML model(s) 1125 to be included in the ensemble because the chosen ML model(s) 1125 are effective at accurately processing particular types of input(s) 1105, are effective at accurately generating particular types of output(s) 1130, are generally accurate, process input(s) 1105 quickly, generate output(s) 1130 quickly, are computationally efficient, have higher or lower degrees of uncertainty than other models in the ensemble, or a combination thereof.

In some examples, one or more of the ML model(s) 1125 can be initialized with weights, connections, and/or hyperparameters that are selected randomly. This can be referred to as random initialization. These weights, connections, and/or hyperparameters are modified over time through training (e.g., initial training with the training data 1160 and/or update(s) 1155 based on the feedback 1150), but the random initialization can still influence the way the ML model(s) 1125 process data, and thus can still cause different ML model(s) 1125 (with different random initializations) to produce different output(s) 1130. Thus, in some examples, different ML model(s) 1125 in an ensemble can have different random initializations.

As an ML model (of the ML model(s) 1125) is trained (e.g., along the initial training with the training data 1160, update(s) 1155 based on the feedback 1150, and/or other modification(s)), different versions of the ML model at different stages of training can be referred to as checkpoints. In some examples, after each new update to a model (e.g., update 1155) generates a new checkpoint for the model, the ML engine 1120 tests the new checkpoint (e.g., against testing data and/or validation data where the correct output(s) are known) to identify whether the new checkpoint improves over older checkpoints or not, and/or if the new checkpoint introduces new errors (e.g., false positive(s) and/or false negative(s)). This testing can be referred to as checkpoint benchmark scoring. In some examples, in checkpoint benchmark scoring, the ML engine 1120 produces a benchmark score for one or more checkpoint(s) of one or more ML model(s) 1125, and keeps the checkpoint(s) that have the best (e.g., highest or lowest) benchmark scores in the ensemble. In some examples, if a new checkpoint is worse than an older checkpoint, the ML engine 1120 can revert to the older checkpoint. The benchmark score for a can represent a level of accuracy of the checkpoint and/or number of errors (e.g., false positive or false negative) by the checkpoint during the testing (e.g., against the testing data and/or the validation data). In some examples, an ensemble of the ML model(s) 1125 can include multiple checkpoints of the same ML model.

In some examples, the ML model(s) 1125 can be modified, either through the initial training (with the training data 1160), an update 1155 based on the feedback 1150, or another modification to introduce randomness, variability, and/or uncertainty into an ensemble of the ML model(s) 1125. In some examples, such modification(s) to the ML model(s) 1125 can include dropout (e.g., Monte Carlo dropout), in which one or more weights or connections are selected at random and removed.

In some examples, dropout can also be performed during inference, for instance to modify the output(s) 1130 generated by the ML model(s) 1125. The term Bayesian Machine Learning (BML) can refer to random dropout, random initialization, and/or other randomization-based modifications to the ML model(s) 1125. In some examples, the modification(s) to the ML model(s) 1125 can include a hyperparameter search and/or adjustment of hyperparameters. The hyperparameter search can involve training and/or updating different ML models 1125 with different values for hyperparameters and evaluating the relative performance of the ML models 1125 (e.g., against (e.g., against testing data and/or validation data where the correct output(s) are known) to identify which of the ML models 1125 performs best. Hyperparameters can include, for instance, temperature (e.g., influencing level creativity and/or randomness), top P (e.g., influencing level creativity and/or randomness), frequency penalty (e.g., to prevent repetitive language between one of the output(s) 1130 and another), presence penalty (e.g., to encourage the ML model(s) 1125 to introduce new data in the output(s) 1130), other parameters or settings, or a combination thereof.

In some examples, the ML engine 1120 can perform retrieval-augmented generation (RAG) using the model(s) 1125. For instance, in some examples, the ML engine 1120 can pre-process the input(s) 1105 by retrieving additional information from one or more data store(s) (e.g., any of the databases and/or other data structures discussed herein) and using the additional information to enhance the input(s) 1105 before the input(s) 1105 are processed by the ML model(s) 1125 to generate the output(s) 1130. For instance, in some examples, the enhanced versions of the input(s) 1105 can include the additional information that the ML engine 1120 retrieved from the from one or more data store(s). In some examples, this RAG process provides the ML model(s) 1125 with more relevant information, allowing the ML model(s) 1125 to generate more accurate and/or personalized output(s) 1130.

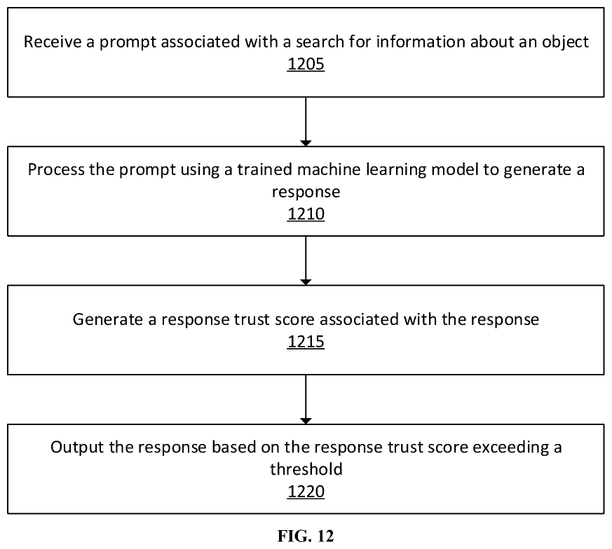

FIG. 12 is a flow diagram illustrating an example of a process for trust assessment in interactive search, according to some examples. Operations are performed using an analysis system, which may include, for instance, the object generation and trust assessment system 100, the first system 102, the server system 104, the second system 120, the user device 128, system(s) that perform any of the process(es) illustrated in the flow diagrams through FIGS. 2 through 8, a computing system and/or computing device with at least one processor performing instructions stored in at least one memory (and/or in a non-transitory computer-readable storage medium), a system, and apparatus, or a combination thereof.

At operation 1205, the analysis system receives a prompt associated with a search for information (e.g., SIO data elements) about an object. Examples of the prompt include a prompt associated with the prompt module 108, a prompt associated with the LLM module 110, a prompt associated with the iterative refinement module 112, selection of the SIO objects of operation 208, the user data of operation 302, the user data of operation 402, the query of operation 404 and/or operation 406, the selection of SIO objects of operation 410, prompt of operation 506, the user input of operation 608, the user data of operation 806, prompt 1035, prompt 1110, other prompts discussed herein, or a combination thereof. In some examples, the prompt can include a query, or can be associated with a query, such as the query of operations 404-406, the additional SIO queries of operation 412, the query of operation 604, the query 1030, a query associated with the prompt 1110, or a combination thereof.

In some examples, the prompt is based on a user input and data from a data structure (e.g., SIO database 118). In some examples, the user input includes a search query including at least one data element relating to the object. In some examples, the analysis system authenticates an identity of a user based on an additional user input associated with the user. In some examples, the additional user input may comprise a username, user ID, email address, or a combination thereof, or a form of authentication such as a password, biometric, identification card, or a combination thereof. In some examples, the user input includes an approval (e.g., by a user) confirming that the prompt contains at least one data element relating to the object.

At operation 1210, the analysis system processes the prompt using a trained machine learning model to generate a response. Examples of the trained machine learning model include ML model(s) associated with the LLM module 110, ML model(s) associated with the iterative refinement module 112, ML model(s) associated with the assessment module 116, the LLM of operation 212 and/or operations 216-218, the LLM of operation 504 and/or operations 512-518, the LLM of operation 602 and operation 606 and operations 610-612, the LLM of operations 702-706, the model(s) 1025, the ML model(s) 1125, other ML model(s) discussed herein, or a combination thereof. Examples of the response include response(s) generated using the LLM module 110, the LLM response of operation 212, the modified LLM response of operation 216, the LLM response of operations 516-518, the LLM response of operation 602, the modified LLM response of operations 610-612, the modified LLM response of operations 702-706, the response(s) 1055, the response(s) 1132, the regenerated response(s) 1134, other response(s) discussed herein, or a combination thereof. In some examples, the response is responsive to the prompt, and the response includes the information about the object retrieved from the data structure (e.g., SIO database 118) as a result of the search. In some examples, at least a portion of the response is converted into an SIO data structure. In some examples, the analysis system retrieves the data from the data structure using retrieval-augmented generation (RAG).

At operation 1215, the analysis system generates a response trust score associated with the response. Examples of the response trust score include trust scores generated using the assessment module 116, the authenticity data of operations 810-814, the response trust score(s) 1136, or a combination thereof. In some examples, the response trust score is based on one or more trust scores associated with the information about the object retrieved from the data structure. Examples of such trust scores include trust scores generated using the assessment module 116, the SIO authenticity data of operation 226, the SIO trust scores of operation 808, the trust scores in the rightmost column of the table of FIG. 9, trust scores stored in the data store system(s) 1015, trust scores in the input(s) 1105, or a combination thereof. In some examples, a first trust score of the one or more trust scores is associated with a first data element of the information, and wherein a second trust score of the one or more trust scores is associated with a second data element of the information. For example, the first trust score is associated with a first SIO object associated with the SIO object received from the assessment module 116. In some examples, the response trust score is based on a first product and a second product. In other examples, the trust score may utilize weighting based upon the degree to which the associated object and/or user influences the accuracy of the received SIO object. In such examples, the first product is based on the first trust score and a first weight, and the second product is based on the second trust score and a second weight. For example, associated SIO objects may be divided between primary and secondary associations, such that primary associations have a significant relationship to the authenticity of the SIO object, and where secondary associations have a lesser relationship to the authenticity of the SIO object. In some examples, the response trust score is a weighted average that is based on the first trust score, the first weight, the second trust score, and the second weight.

In some examples, the analysis system may generate an assessment of authenticity associated with the response, by classifying a level of authenticity of the response. In some examples, the level of authenticity comprises a binary assessment (e.g., true or false) of authenticity. In other examples, the level of authenticity can be determined in different levels of authenticity based on different numerical scales (e.g., from 0 to 10 or 0 to 100) of the response trust scores. For examples, the response authenticity data can comprise a trust score of 78. In other examples, the authentication data may additionally comprise a qualitative indication that the authentication method utilized was an automated comparison of SIO object data and an aggregation of trust scores. The authenticity data generated for the SIO objects are saved to the SIO database 118.

At operation 1220, the analysis system outputs the response based on the response trust score exceeding a threshold. In some examples, the analysis system generates the one or more trust scores based on a user trust score of a user. In such examples, the user trust score is based on one or more associations between one or more SIO's and a past user input associated with the user. Further, the response trust score can be based on the user trust score and the one or more trust scores associated with the information about the object retrieved from the data structure.

What is claimed is:

1. A method for trust assessment in interactive search, the method comprising:
receiving a prompt associated with a search for information about an object, wherein the prompt is based on a user input and data from a data structure;
processing the prompt using a trained machine learning model to generate a response, wherein the response is responsive to the prompt, and wherein the response includes the information about the object retrieved from the data structure as a result of the search;
generating a response trust score that indicates of an estimated accuracy of the response, wherein the response trust score is based on a user trust score associated with a user and one or more trust scores associated with the information about the object retrieved from the data structure; and
outputting the response based on the response trust score exceeding a threshold.

2. The method of claim 1, further comprising:
converting at least a portion of the response into a second data structure.

3. The method of claim 1, further comprising:
authenticating an identity of a user based on a user input associated with the user, wherein the prompt is based on a second user input associated with the user.

4. The method of claim 3, wherein the second user input includes a search query including at least one data element relating to the object.

5. The method of claim 1, wherein a first trust score of the one or more trust scores is associated with a first data element of the information, and wherein a second trust score of the one or more trust scores is associated with a second data element of the information.

6. The method of claim 5, wherein the response trust score is based on a first product and a second product, wherein the first product is based on the first trust score and a first weight, wherein the second product is based on the second trust score and a second weight.

7. The method of claim 6, wherein the response trust score is a weighted average that is based on the first trust score, the first weight, the second trust score, and the second weight.

8. The method of claim 1, further comprising:
retrieving the data from the data structure using retrieval-augmented generation (RAG).

9. The method of claim 1, further comprising:
generating the one or more trust scores based on the user trust score.

10. The method of claim 9, wherein the user trust score is based on one or more associations between one or more data elements of the information and a past user input associated with the user.

11. (canceled)

12. The method of claim 1, further comprising:
generating an assessment of authenticity associated with the response, wherein the assessment classifies a level of authenticity of the response.

13. The method of claim 1, further comprising:
determining a level of authenticity associated with the response from different levels of the authenticity based on the response trust score.

14. The method of claim 1, wherein the user input includes an approval confirming that the prompt contains at least one data element relating to the object.

15. A system for trust assessment in interactive search, the system comprising:
a memory that stores instructions; and
a processor that executes the instructions, wherein execution of the instructions by the processor causes the processor to:
receive a prompt associated with a search for information about an object,
wherein the prompt is based on a user input and data from a data structure;
process the prompt using a trained machine learning model to generate a response, wherein the response is responsive to the prompt, and wherein the response includes the information about the object retrieved from the data structure as a result of the search;
generate a response trust score that indicates of an estimated accuracy of the response, wherein the response trust score is based on a user trust score associated with a user and one or more trust scores associated with the information about the object retrieved from the data structure; and
output the response based on the response trust score exceeding a threshold.

16. A non-transitory computer-readable storage medium, having embodied thereon a program executable by a processor to perform a method for trust assessment in interactive search, the method comprising:
receiving a prompt associated with a search for information about an object, wherein the prompt is based on a user input and data from a data structure;
processing the prompt using a trained machine learning model to generate a response, wherein the response is responsive to the prompt, and wherein the response includes the information about the object retrieved from the data structure as a result of the search;
generating a response trust score that indicates of an estimated accuracy of the response, wherein the response trust score is based on a user trust score associated with a user and one or more trust scores associated with the information about the object retrieved from the data structure; and
outputting the response based on the response trust score exceeding a threshold.

17. The non-transitory computer-readable storage medium of claim 16, wherein a first trust score of the one or more trust scores is associated with a first data element of the information, and wherein a second trust score of the one or more trust scores is associated with a second data element of the information.

18. The non-transitory computer-readable storage medium of claim 17, wherein the response trust score is based on a first product and a second product, wherein the first product is based on the first trust score and a first weight, wherein the second product is based on the second trust score and a second weight.

19. The non-transitory computer-readable storage medium of claim 18, wherein the response trust score is a weighted average that is based on the first trust score, the first weight, the second trust score, and the second weight.

20. The non-transitory computer-readable storage medium of claim 16, further comprising:
retrieving the data from the data structure using retrieval-augmented generation (RAG).
